(19) United States
(12) Patent Application Publication
(10) Pub. No.: US 2004/0230340 A1
(43) Pub. Date: Nov. 18, 2004

(54) Behavior controlling apparatus, behavior control method, behavior control program and mobile robot apparatus

(76) Inventors: Masaki Fukuchi, Tokyo (JP); Kohtaro Sabe, Tokyo (JP)

Correspondence Address: William S. Frommer, Esq., FROMMER LAWRENCE & HAUG LLP, 745 Fifth Avenue, New York, NY, 10151, US

(21) Appl. No.: 10/810,188

(22) Filed: Mar. 26, 2004

(30) Foreign Application Priority Data
Mar. 28, 2003 (JP) 2003-092350

(51) Int. Cl. G06F 19/00

(52) U.S. Cl. 700/245; 318/568.12

(57) ABSTRACT

A behavior controlling apparatus by which the mobility area of a robot apparatus may be controlled in a simplified manner using plural landmarks. A landmark recognition unit 410 uniquely recognizes the landmarks to acquire the landmark position information rPo(x,y,z). A landmark map building unit 420 integrates the totality of the landmark position information rPo(x,y,z) sent by the landmark recognition unit 410 to build a landmark map which has integrated the geometric topology of the landmarks. Using the landmark map information rPo×N, a mobility area recognition unit 430 builds a mobility area map representing a mobility area for the robot. Using the mobility area map, sent from the mobility area recognition unit 430, a behavior controller 440 controls the autonomous behavior of the robot apparatus 1 so that the robot apparatus 1 will not come out of or into the mobility area.

### BACKGROUND OF THE INVENTION

1. Field of the Invention

This invention relates to a behavior controlling apparatus and a behavior control method and, more particularly, to a behavior controlling apparatus, a behavior control method and a behavior control program applied to a mobile robot apparatus in order that the mobile robot apparatus may be moved as it recognizes objects placed on a floor surface. This invention relates to a mobile robot apparatus that is autonomously moved as it recognizes objects placed on a floor surface.

This application claims the priority of the Japanese Patent Application No. 2003-092350 filed on Mar. 28, 2003, the entirety of which is incorporated by reference herein.

2. Description of Related Art

A mechanical apparatus for performing movements like those of the human being, using electrical or magnetic operations, is termed a “robot”. The robot started to be used in this nation extensively towards the end of the sixties. Most of the robots used were industrial robots, such as a manipulator and a transport robot, aimed at automating or the production or performing unmanned operations in plants.

In recent years, developments of utility robots, supporting the human life as a partner to the human being, that is, supporting the human activities in various aspects in our everyday life, such as in our living environment, are progressing. In distinction from the industrial robots, these utility robots have the ability of learning the methods of adapting themselves to the human being with different personalities or to the variable environments in the variable aspects of the living environments of the human beings. For example, pet type robots, simulating the bodily mechanism or movements of animals, such as quadruples, e.g. dogs or cats, or so-called humanoid robots, simulating the bodily mechanism or movements of the human being, walking on two legs, such as human beings, are already being put to practical use.

As compared to the industrial robots, these utility robots are capable of performing variable movements, with emphasis placed on entertainment properties, and hence are also termed entertainment robots. Some of these entertainment robot apparatuses operate autonomously, responsive to the information from outside or to the inner states.

Meanwhile, as the industrial robots, a so-called working robot is used, which performs operations as it recognizes an operating area using the magnetic information or a line laid on a construction site or in a plant, as disclosed in for example the Japanese Laying-Open Patent Publication H6-226683. A working robot is also used which performs operations within only a permitted area in a plant using an environmental map which is provided from the outset.

However, the working robot, disclosed in the aforementioned Patent Publication H6-226683, is a task executing type robot which performs the operations based on the map information provided from the outset, and which is not acting autonomously.

Moreover, when the line laying or the magnetic information is to be changed on a construction site or in a plant, in readiness for change of the movement area of the working robot, time and labor are needed in the changing operations. In particular, the line laying operation is laborious in a plant of a large scale. Additionally, the degree of freedom is limited in the plant.

Conversely, with the autonomous robot apparatus, the ability of recognizing the surrounding environment to verify obstacles to perform the movements accordingly is naturally crucial.

### SUMMARY OF THE INVENTION

In view of the above-depicted status of the art, it is an object of the present invention to provide a behavior controlling apparatus, a behavior controlling method and a behavior controlling program, for controlling the mobility area of an autonomously moving mobile robot apparatus, using a landmark. It is another object of the present invention to provide a mobile robot apparatus which may readily limit the mobility area using a landmark.

For accomplishing the above objects, the present invention provides a behavior controlling apparatus for controlling the behavior of a mobile robot apparatus, in which the behavior controlling apparatus comprises landmark recognition means for recognizing a plurality of landmarks arranged discretely, landmark map building means for integrating the locations of the landmarks recognized by the landmark recognition means for building a landmark map based on the geometrical topology of the landmarks, mobility area recognition means for building a mobility area map, indicating the mobility area where the mobile robot apparatus can move, from the landmark map built by the landmark map building means, and behavior controlling means for controlling the behavior of the mobile robot apparatus using the mobility area map built by the mobility area recognition means.

The present invention also provides a behavior controlling method for controlling the behavior of a mobile robot apparatus, in which the behavior controlling method comprises a landmark recognition step of recognizing a plurality of landmarks arranged discretely, a landmark map building step of integrating the locations of the landmarks recognized by the landmark recognition step of building a landmark map based on the geometrical topology of the landmarks, a mobility area recognition step of building a mobility area map, indicating the mobility area where the mobile robot apparatus can move, from the landmark map built by the landmark map building means, and a behavior controlling step of controlling the behavior of the mobile robot apparatus using the mobility area map built by the mobility area recognition means.

The present invention also provides a behavior controlling program run by a mobile robot apparatus for controlling the behavior of the mobile robot apparatus, in which the behavior controlling program comprises a landmark recognition step of recognizing a plurality of landmarks arranged discretely, a landmark map building step of integrating the locations of the landmarks recognized by the landmark recognition step of building a landmark map based on the geometrical topology of the landmarks, a mobility area recognition step of building a mobility area map, indicating the mobility area where the mobile robot apparatus can move, from the landmark map built by the landmark map building means, and a behavior controlling step of controlling the behavior of the mobile robot apparatus using the mobility area map built by the mobility area recognition means.

The present invention also provides a mobile robot apparatus including at least one movable leg and a trunk provided with information processing means, with the mobile robot apparatus moving on a floor surface as the apparatus recognizes an object on the floor surface, in which the mobile robot apparatus comprises landmark recognition means for recognizing a plurality of landmarks arranged discretely, landmark map building means for integrating the locations of the landmarks recognized by the landmark recognition means for building a landmark map based on the geometrical topology of the landmarks, mobility area recognition means for building a mobility area map, indicating the mobility area where the mobile robot apparatus can move, from the landmark map built by the landmark map building means, and behavior controlling means for controlling the behavior of the mobile robot apparatus using the mobility area map built by the mobility area recognition means.

In the present invention, the behavior controlling apparatus finds the mobility area of the robot apparatus, from the geometrical topology of the landmarks, and controls the behavior of the robot apparatus in accordance with the mobility area.

With the robot apparatus 1 of the present embodiment, the behavior control device finds the mobility area of the robot apparatus from the geometrical topology of the landmarks and controls the behavior of the robot apparatus in accordance with this mobility area.

According to the present invention, in which discretely arranged landmarks are recognized, the positions of the recognized landmarks are integrated, a landmark map is built, based on the geometrical topology of the landmarks, a mobility area map, indicating the mobility area where the mobile robot apparatus can move, is built from the landmark map, and the autonomous behavior of the mobile robot apparatus is controlled, using the so built mobility area map, the mobility area of the mobile robot apparatus may be set in a simplified manner. The mobile robot apparatus may be caused to act within the area as intended by a user. Moreover, the mobile robot apparatus may be prevented from going to a place which may be dangerous for the robot, such as stairway or a place below a desk.

### BRIEF DESCRIPTION OF THE DRAWINGS

FIG. 1, showing the appearance and a structure of a robot apparatus embodying the present invention, is a perspective view of a humanoid robot apparatus walking on two legs.

FIG. 2, showing the appearance and a structure of a robot apparatus embodying the present invention, is a perspective view of animal type robot apparatus walking on four legs.

FIG. 3 is a block diagram showing schematics of a robot apparatus embodying the present invention.

FIG. 4 is a schematic view showing the structure of the software for causing movements of the robot apparatus embodying the present invention.

FIG. 5 is a functional block diagram of a behavior controlling apparatus applied to the robot apparatus.

FIG. 6 is a schematic view showing examples of the landmarks.

FIG. 7A to C shows how a robot apparatus comes to act autonomously in a mobility area of the robot apparatus.

FIGS. 8A to D show the flow of package wrapping algorithm.

FIGS. 9A to 9F show specified examples of a mobility area map formed by convex closure.

FIGS. 10A to 10C show specified examples of the mobility area map built by an area method.

FIGS. 11A to 11C show specified examples of the mobility area map built by the potential field.

FIGS. 12A to 12C show specified examples of a mobility area setting method that is switched at the time of preparation of the mobility area map depending on the number of the landmarks.

FIG. 13 is a functional block diagram of an obstacle recognizing apparatus.

FIG. 14 illustrates generation of a disparity image entered to a planar surface extraction unit PLEX.

FIG. 15 is a flowchart showing the processing sequence in which the planar surface extraction unit PLEX recognizes an obstacle.

FIG. 16 shows parameters of a planar surface as detected by the planar surface extraction unit PLEX.

FIG. 17 illustrates the processing of conversion from a camera coordinate system to a foot sole touchdown plane coordinate system.

FIG. 18 shows a point on a planar surface as extracted by the planar surface extraction unit PLEX.

FIGS. 19A to 19C shows extraction of a floor surface from a robot view followed by coordinate transformation to represent an obstacle two-dimensionally on a planar floor surface.

FIG. 20 shows a specified example of an environment in which is placed a robot apparatus.

FIG. 21 shows a specified example of an obstacle map.

FIG. 22 is a flowchart showing the software movement of the robot apparatus embodying the present invention.

FIG. 23 is a schematic view showing the data flow as entered to the software.

FIG. 24 schematically shows a model of the structure of the degrees of freedom of the robot apparatus embodying the present invention.

FIG. 25 is a block diagram showing a circuit structure of the robot apparatus.

FIG. 26 is a block diagram showing the software structure of the robot apparatus.

FIG. 27 is a block diagram showing the structure of the middleware layer of the software structure of the robot apparatus.

FIG. 28 is a block diagram showing the structure of the application layer of the software structure of the robot apparatus.

FIG. 29 is a block diagram showing the structure of a behavior model library of the application layer.

FIG. 30 illustrates a finite probability automaton as the information for determining the behavior of the robot apparatus.

FIG. 30 illustrates the finite probability automaton which becomes the information for determining the behavior of the robot apparatus.

FIG. 31 shows a status transition table provided for each node of the finite probability automaton.

### DESCRIPTION OF PREFERRED EMBODIMENTS

Referring to the drawings, certain preferred embodiments of the present invention are explained in detail. An embodiment is now explained which is directed to a mobile robot apparatus employing a behavior controlling apparatus according to the present invention. The behavior controlling apparatus finds the area within which the robot apparatus is able to act (mobility area of the robot apparatus), from the geographical topology of the landmarks, to control the robot apparatus in accordance with the mobility area.

As the mobile robot apparatus, carrying this behavior controlling apparatus, the humanoid robot apparatus for entertainment, walking on two legs, and the animal type robot apparatus, walking on four legs, may be used. Such a robot apparatus may also be used which is provided with wheels on one or more or all of legs for self-running by an electrical motive power.

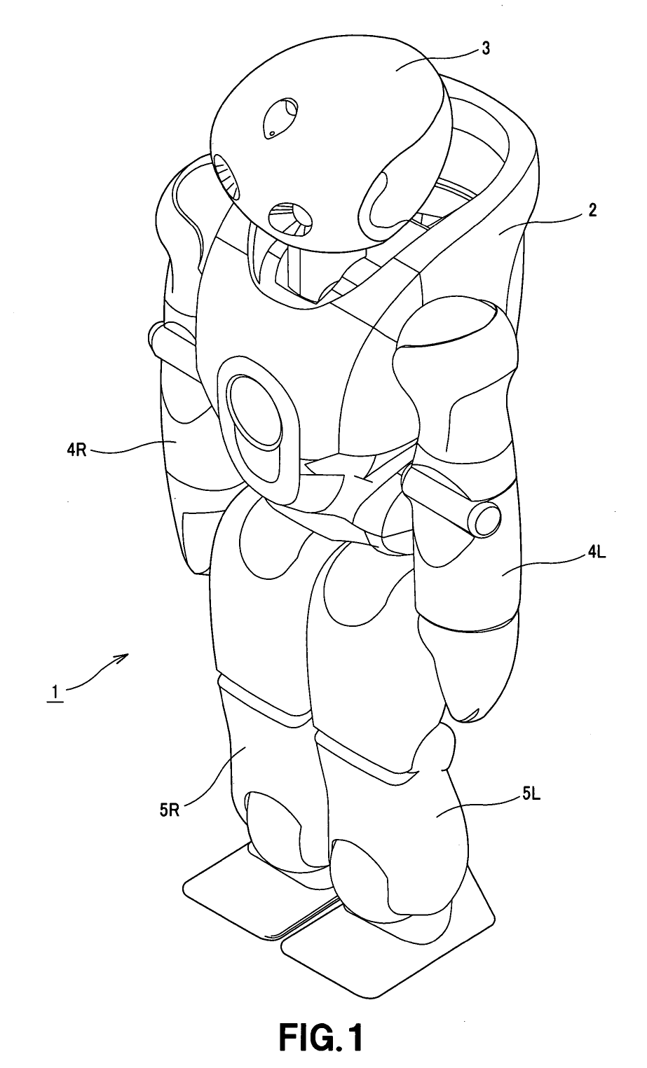

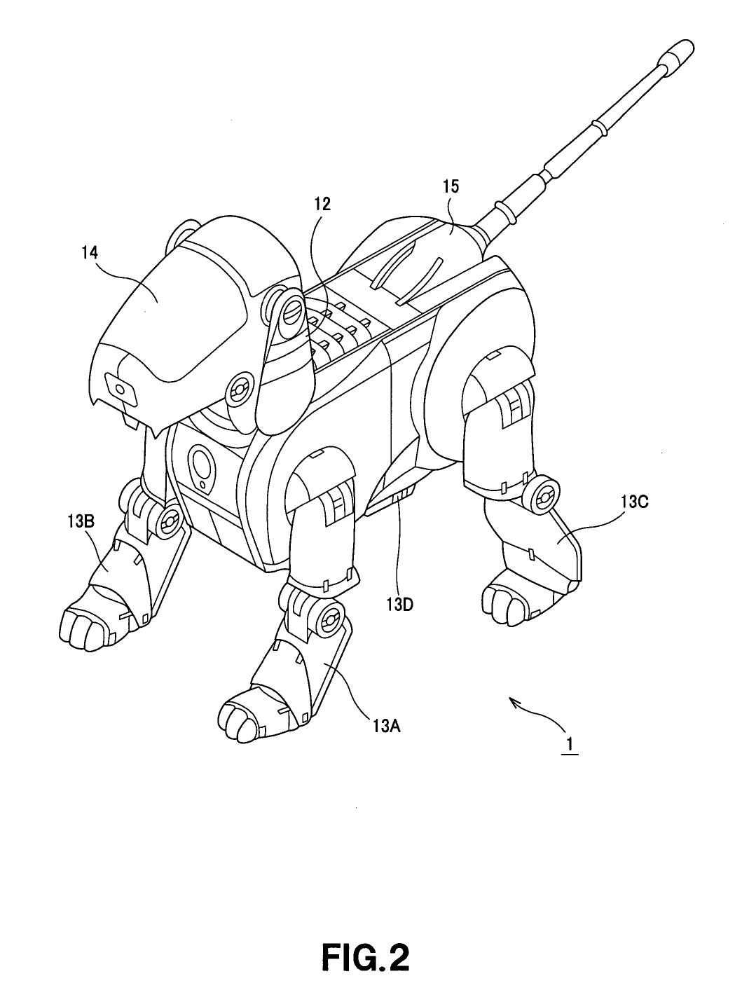

As the robot apparatus, walking on two legs, there is such a robot apparatus 1, including a body trunk unit 2, a head unit 3, connected to a preset location of the body trunk unit 2, left and right arm units 4R/L and left and right leg units 5R/L, also connected to preset locations of the body trunk unit, as shown in FIG. 1. It should be noted that R and L are suffixes indicating right and left, respectively, as in the following. As the animal type robot apparatus, walking on four legs, there is a so-called pet robot, simulating the ‘dog’, as shown in FIG. 2. This robot apparatus 11 includes leg units 13A to 13D, connected to the front, rear, left and right sides of a body trunk unit 12, a head unit 14 and a tail unit 15 connected to the front and rear sides of the body trunk unit 12, respectively.

These robot apparatus each include a small-sized camera, employing a CCD (charge coupled device)/CMOS (complementary metal oxide semiconductor) imaging unit, as a visual sensor, and is able to acquire landmarks, as discretely arranged artificial marks, by image processing, to acquire the relative positions of the landmarks with respect of the robot apparatus. In the present embodiment, this unit is used as a landmark sensor. The following description of the present embodiment is directed to a humanoid robot apparatus walking on two legs.

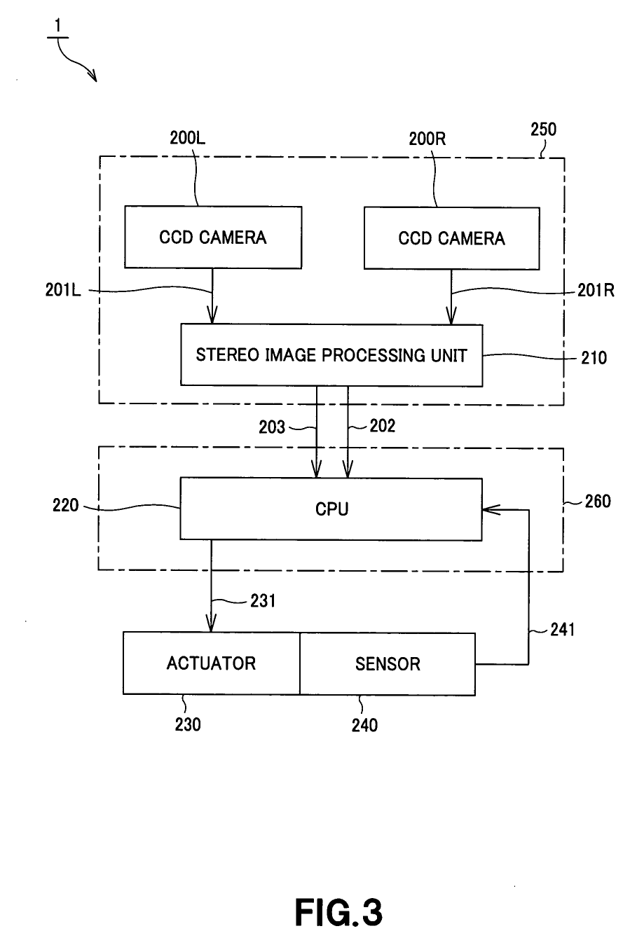

FIG. 3 depicts a block diagram showing the schematics of the robot apparatus walking on two legs. Referring to FIG. 3, a head unit 250 of the robot apparatus 1 is provided with two CCD cameras 200R, 200L. On the trailing side of the CCD cameras 200R, 200L, there is provided a stereo image processing unit 210. A right eye image 201R and a left eye image 201L, photographed by two CCD cameras (referred to below as a right eye 200R and a left eye 200L, respectively), are entered to the stereo image processing unit 210. This stereo image processing unit 210 calculates the parallax information (disparity data) of the images 201R, 201L, as the distance information, and alternately calculates left and right color images (YUV: luminance Y, chroma UV) 202 and left and right disparity images (YDR: luminance Y, disparity D and reliability R) on the frame basis. The disparity means the difference in the dots mapped from a given point in the space on the left and right eyes, this difference being changed with the distance from the camera.

The color images 202 and the disparity images 203 are entered to a CPU (controller) 220 enclosed in a body trunk unit 260 of the robot apparatus 1. An actuator 230 is provided to each joint of the robot apparatus 1 and is supplied with a control signal 231 operating as a command from the CPU 220 to actuate an associated motor in dependence upon the command value. Each joint (actuator) is provided with a potentiometer and an angle of rotation at each given time point is sent to the CPU 220. A plural number of sensors 240, including a potentiometer, mounted to the actuator, a touch sensor mounted to the foot sole, or a gyro sensor mounted to the body trunk unit, measure the current status of the robot apparatus, such as the current joint angle, mounting information and the posture information, and outputs the current status of the robot apparatus as sensor data 241 to the CPU 220. The CPU 220 is supplied with the color images 202 and the disparity images 203 from the stereo image processing unit 210, while being supplied with sensor data 241, such as all joint angles of the actuators. These data are processed by the software as later explained to enable various movements to be carried out autonomously.

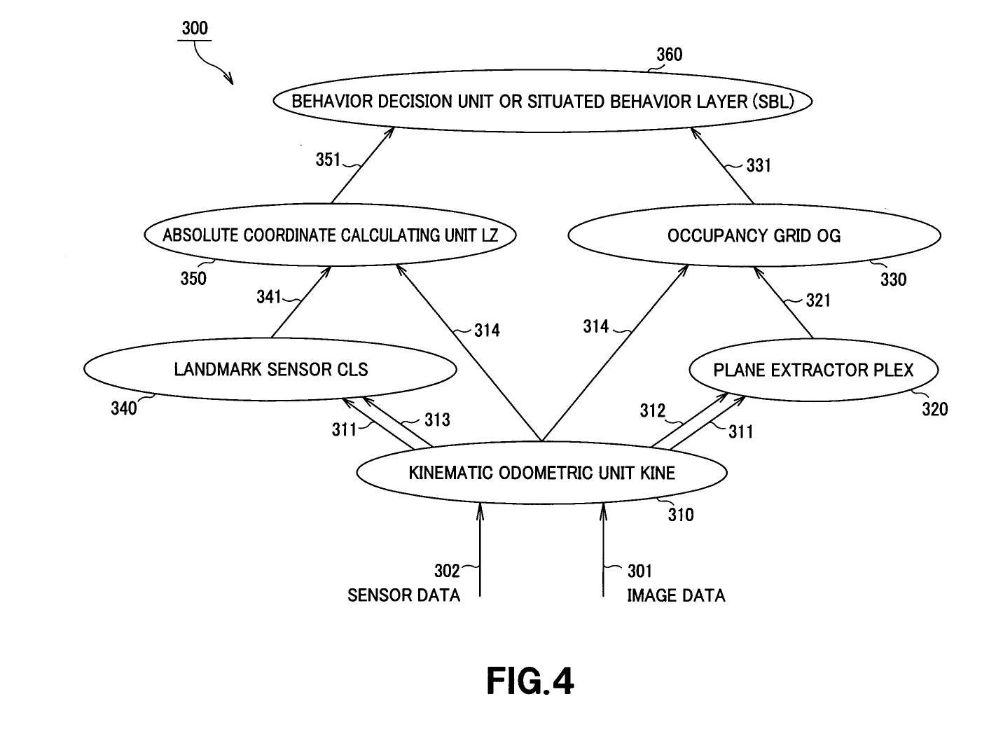

FIG. 4 schematically shows the software structure for causing movements of the robot apparatus of the present embodiment. The software in the present embodiment is constructed on the object basis, and recognizes the position, amount of movement, near-by obstacles, landmarks, a landmark map and a mobility area, to output a sequence of behaviors to be ultimately performed by the robot apparatus. Meanwhile, as the coordinate system for indicating the position of the robot apparatus, two coordinate systems, that is, a camera coordinate system of the world reference system, having a specified article, such as a landmark, as the point of origin of the coordinate, referred to below as an absolute coordinate system, and a robot-centered coordinate system, centered about the robot apparatus itself (point of origin of the coordinate), referred to below as a relative coordinate system, for example, are used.

The objects communicate with one another asynchronously to cause the operation of the entire system. Each object exchanges data and invokes the program (booting) by an object-to-object communication method exploiting message communication and a co-owned memory. A software 300 of the robot apparatus of the present embodiment is made up by a kinematic odometric unit KINE 310, a plane extractor PLEX 320, an occupancy grid OG 330, a landmark sensor CLS 340, an absolute coordinate calculating unit or localization unit LZ 350, and a behavior decision unit or situated behavior layer (SBL) 360, and performs the processing on the object basis. The kinematic odometric unit KINE 310 calculates the distance traversed by the robot apparatus, and the plane extractor PLEX 320 extracts the plane in the environment. The occupancy grid OG 330 recognizes an obstacle in the environment, and the landmark sensor CLS 340 specifies the own position (position and the posture) of the robot apparatus or the position information of the landmark as later explained. The absolute coordinate calculating unit or localization unit LZ 350 transforms the robot-centered coordinate system to the absolute coordinate system, while the behavior decision unit or situated behavior layer (SBL) 360 determines the behavior to be performed by the robot apparatus. It should be noted that the landmark sensor CLS 340 is similar to a landmark recognition unit 410 as later explained.

When applied to a robot apparatus, the behavior controlling apparatus finds the area within which may act the robot apparatus, from the geometrical topology of the landmarks, and controls the behavior of the robot apparatus in accordance with this area within which may act the robot apparatus. The autonomous operations as well as the structure and the operations of the robot apparatus will be explained subsequently.

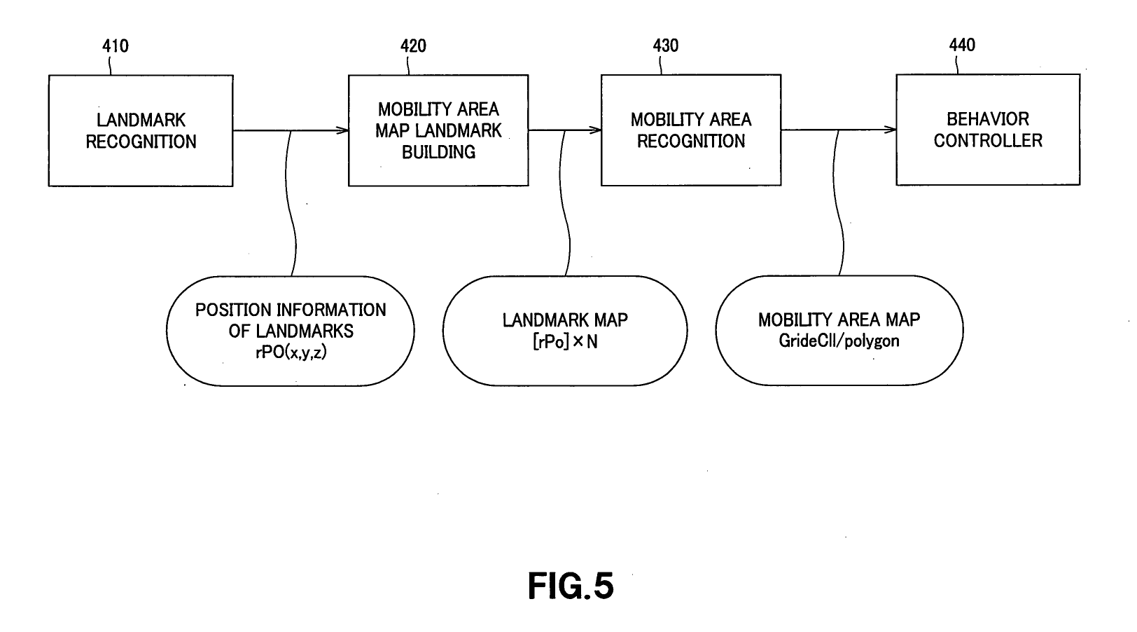

FIG. 5 depicts the functional structure of the behavior controlling apparatus, loaded on the robot apparatus 1. The behavior controlling apparatus is constructed within the CPU 220. Functionally, the behavior controlling apparatus includes a landmark recognition unit 410, for recognizing landmarks, a landmark map building unit 420, for building the landmark map, a mobility area recognition unit 430, for building a mobility area map, and a behavior controller 440, for controlling the autonomous behavior of the robot apparatus.

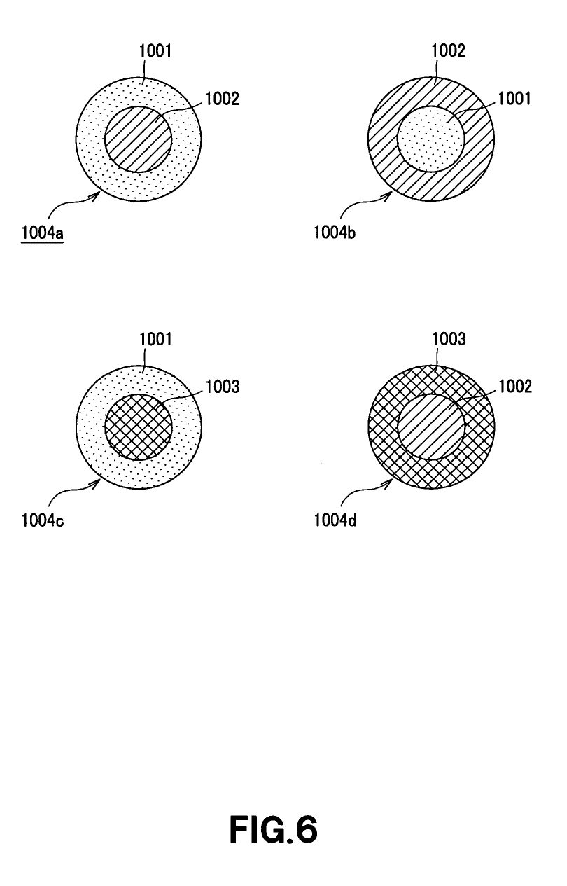

By employing this behavior controlling apparatus, the robot apparatus 1 first recognizes the landmarks by a landmark recognition unit 410. Referring to FIG. 6, the landmark is formed by the combination of two concentric color zones, each of which may be a purple zone 1001, a yellow zone 1002 or a pink zone 1003. A landmark 1004a has the inner concentric zone of yellow 1002 and an outer concentric zone of purple 1001. A landmark 1004b has the inner concentric zone of purple 1001 and an outer concentric zone of yellow 1002, while a landmark 1004c has the inner concentric zone of pink 1003 and an outer concentric zone of yellow 1002, and a landmark 1004d has an inner concentric zone of yellow 1002 and an outer concentric zone of pink 1003. These landmarks may be uniquely identified based on the combination of two colors.

It should be noted that the landmarks may use three different geometric patterns of a triangle, a square and a circle, and four colors of red, blue, yellow and green, in different combinations, whereby uniquely identifiable plural sorts of landmarks may be obtained. By using the geometrical patterns of the square, circle and the triangle, fixing the topology of the respective patterns, and by employing four colors of the respective patterns, in combination, a sum total of 24 different landmarks may be produced. In this manner, different landmarks may be formed by the topology and coloring of plural geometrical patterns.

The landmark recognition unit 410 uniquely recognizes the landmarks to obtain the position information rPo(x,y,z) of the landmarks. For finding as many landmarks in the environment as possible, the robot apparatus 1 visits all of the landmarks it has found. First, the robot apparatus 1 starts from a certain point and walks about randomly to take a survey through 360°. Any landmark found in this manner enters into a visit queue. The robot apparatus 1 selects one of the landmarks from the visit queue and walks to the landmark. When the robot apparatus 1 has reached the landmark, the landmark is deleted from the visit queue. The robot apparatus 1 then takes a survey from the landmark to find a new landmark. The newly found landmark is added to the visit queue. By repeating this procedure, the robot apparatus 1 visits the landmarks until the visit queue becomes void. If there is no landmark that cannot be observed from any other landmark, all of the landmarks in the environment can be found by this strategy.

In the present embodiment, the robot apparatus visits the uniquely distinguishable plural artificial landmarks, different in shape and/or in color, present in an environment, by the above-described technique, to send the position information rPo(x,y,z) obtained by the landmark recognition unit 410 to the landmark map building unit 420.

The landmark map building unit 420 integrates the totality of the position information rPo(x,y,z), sent by the landmark recognition unit 410 which has recognized the totality of the landmarks, and builds a landmark map which has integrated the geometrical topology of these landmarks. Specifically, the position information rPo(x,y,z) of the landmarks, recognized by the landmark recognition unit 410, and the odometric information of the robot itself, are integrated to estimate the geometric arrangement of the landmarks to build a landmark map. The landmark map information rPo×N is sent to the mobility area recognition unit 430.

Using the landmark map information rPo×N, the mobility area recognition unit 430 builds a mobility area map representing the area within which the robot is movable. The mobility area map is made up by the information designating grid cells or polygons. The mobility area map is sent to the behavior controller 440.

Using the mobility area map, sent from the mobility area recognition unit 430, the behavior controller 440 controls the autonomous behavior of the robot apparatus 1 so that the robot apparatus will not come out of or into the mobility area.

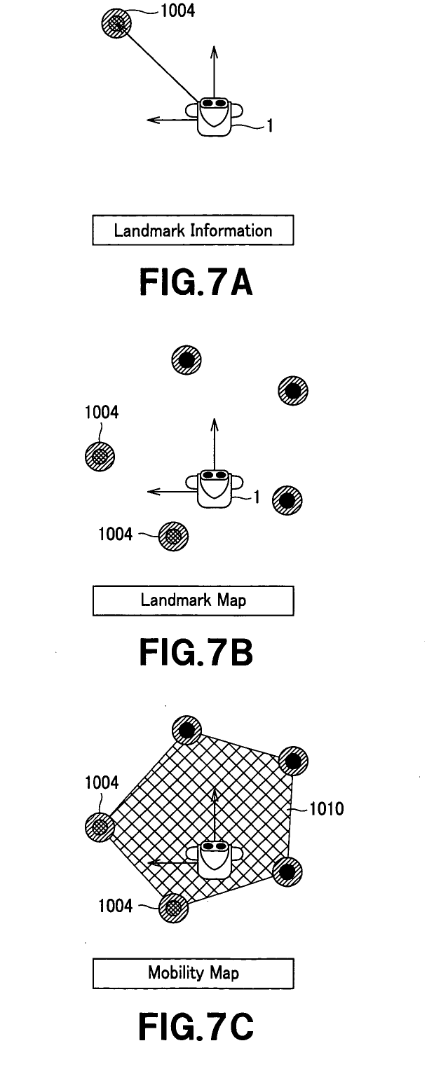

Also referring to FIG. 7 newly, the detailed operation of the behavior controller, made up of the above-depicted components, is explained. FIG. 7 shows, step-by-step, how the robot apparatus 1, carrying the above components 410, 420, 430 and 440, acts autonomously within the mobility area.

The image taken in by the CCD cameras 200R, 200L, shown in FIG. 3, is entered to the stereo image processing unit 210, where the color images (YUV) 202 and the disparity images (YDR) 203 are calculated from the parallax information (distance information) of the right eye image 201R and the left eye image 201L and entered to the CPU 220. The sensor data 240 from the plural sensors, provided to the robot apparatus 1, are also entered. Image data 301, made up by the parallax information and the disparity image, and sensor data 302, are entered to the kinematic odometric unit KINE.

The kinematic odometric unit KINE calculates the amount of movement or traversed distance (odometric information) of the robot-centered coordinate system, based on input data composed of the image data 301 and the sensor data 302. On the other hand, the landmark recognition unit 410 recognizes the landmarks from the color images (YUV) 202 and the disparity images (YDR) 203 as observed by the CCD cameras 200R, 200L. That is, the landmark recognition unit 410 recognizes the color by the above images and specifies the landmarks by the color combination thereof. The landmark recognition unit 410 then estimates the distance from the robot apparatus to the landmark and integrates the so estimated distance to the respective joint information of the robot to estimate the landmark position to output the landmark position information. In this manner, each time the landmark recognition unit 410 recognizes the landmark 1004, the robot apparatus 1 generates the landmark position information (landmark information) (see FIG. 7A) to send the so generated landmark information to the landmark map building unit 420. The robot apparatus detects the own posture direction and sends the information indicating the posture direction along with the distance traversed to the landmark map building unit 420.

The landmark map building unit 420 integrates the landmark information to the information indicating the distance traversed and the posture direction of the robot apparatus (odometric information of the robot itself) to estimate the geometric location of the landmarks to build the landmark map (see FIG. 7B).

The robot apparatus 1 builds, by the mobility area recognition unit 430, a mobility map, indicating the area within which the robot is movable, using the landmark map information (FIG. 7C). The robot apparatus 1 acts autonomously, under control by the behavior controller 440, so that the robot apparatus does not come out from the area of the mobility map.

Meanwhile, in finding the area of mobility, with the aid of the landmark map, prepared by the landmark map building unit 420, the mobility area recognition unit 430 uses one of three algorithms, namely convex closure, an area method, and a potential field.

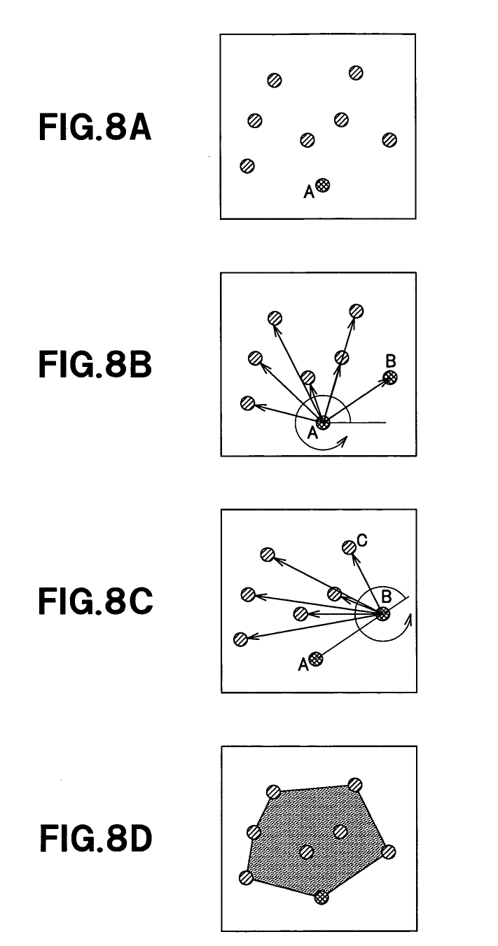

The flow of the package wrapping algorithm, as a typical algorithm of convex closure, is now explained with reference to FIG. 8. First, in a step S1, the two-dimensional coordinate of all landmarks is set to Pn=(x,y) (n=0, 1, 2, . . . , N) (FIG. 8A). In the next step S2, a point pn with the smallest yn from the bottom side along the vertical direction in the drawing sheet is set as A, and a straight line A0 is drawn from A (FIG. 8B). In the next step S3, straight lines APn are drawn from the point A to all Pn excluding A and a point with the least angle between the straight lines APn and A0 is set as B (FIG. 8B). In the next step S4, straight lines BPn are drawn from the point B to all Pn excluding A and B, and a point with the least angle between the straight lines BPn and AB is set as C (FIG. 8C). This step S4 is repeated until reversion to the point A to find the mobility area map (FIG. 8D).

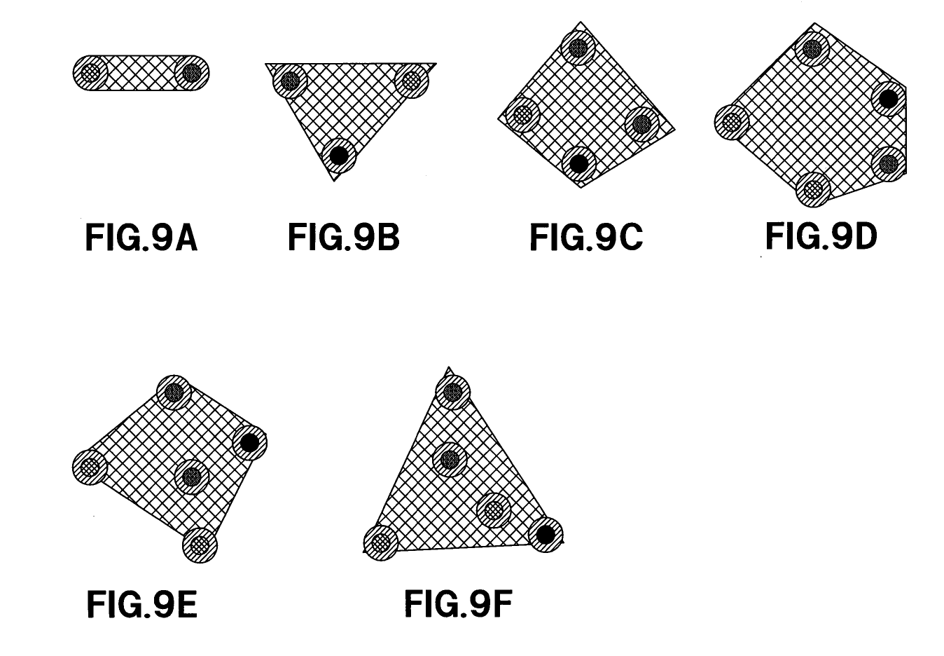

FIG. 9 shows a specified example of the mobility area map built by convex closure. In case the number of the landmarks is 2, 3, 4 and 5, with the landmarks delimiting the apex points of polygons, mobility area maps are built such as to enclose the landmarks, as shown in FIGS. 9A to 9D. There are occasions wherein, as shown in FIGS. 9E and 9F, the mobility area map is built so that the landmarks are wrapped in the inside of a polygon. The mobility area map may also be built so that all of the landmarks are wrapped as being the apex points of an outer rim.

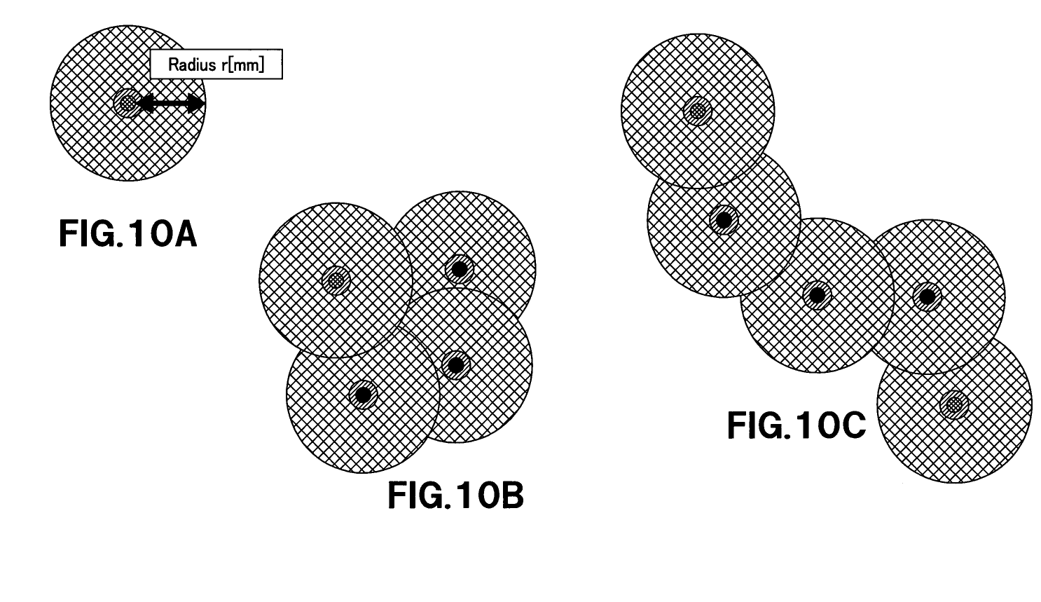

Referring to FIG. 10, a mobility area map by the area method is explained. In the area method, the mobility area is an area having a radius r [m] from a landmark. When there is only one landmark, the area having a radius r [m] from the landmark is the mobility area. If there are four landmarks, as shown in FIG. 10B, the areas with the radii of r [m] from the respective landmarks become the mobility area. Depending on the disposition of the landmarks, the mobility area, obtained on overlaying the respective areas, become substantially S-shaped, as shown in FIG. 10C.

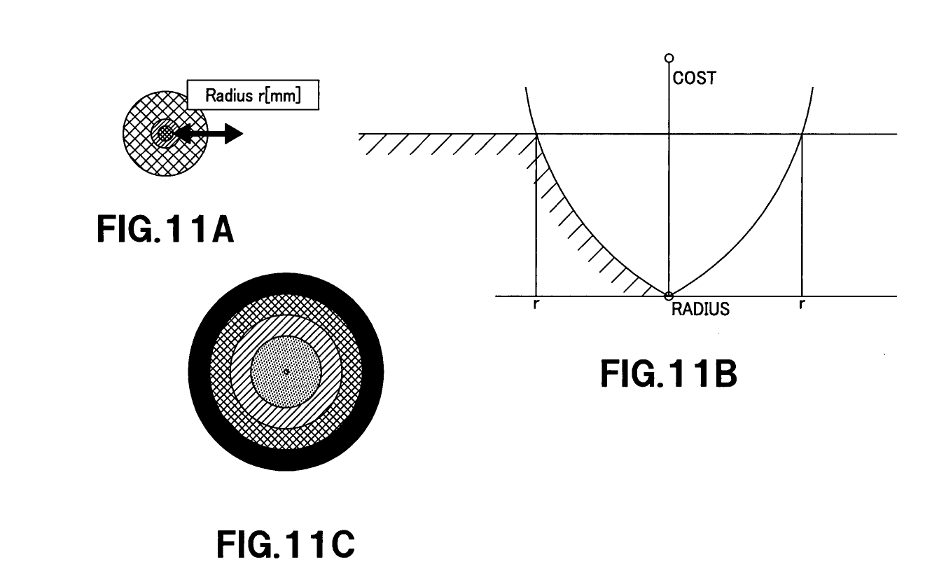

Referring to FIG. 11, a mobility area map by the potential field is explained. The mobility area is an area having a radius r [m] from a landmark (FIG. 11A). The cost which rises with the radial distance from the landmark is defined (FIG. 11B). The result is that a mobility area which rises in cost in a direction towards an outer rim is set, as shown in FIG. 11C.

As an alternative method for setting the mobility area, S [m] may be set closer to the robot than a straight line interconnecting at least twp landmarks located on the forward left and right sides of the robot apparatus 1.

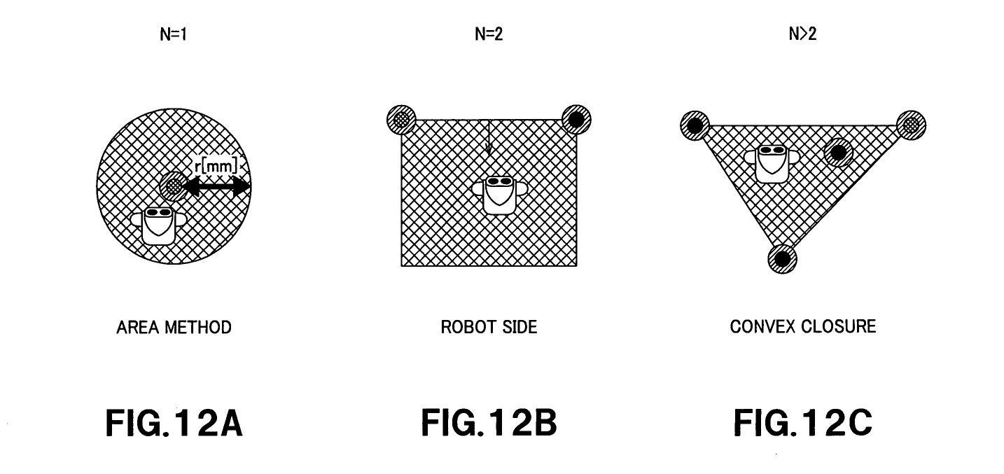

The mobility area recognition unit 430 switches the area setting method at the time of building the mobility area map depending on e.g. the number of the landmarks. Of course, such switching may be made by selection in manual setting. For example, if the number of the landmarks N is 1, the area method, shown in FIG. 12A, may be used, whereas, if the number of the landmarks N is 2, there is S[m] closer to the robot side than a straight line interconnecting two landmarks, within the width of the two landmarks, as shown in FIG. 12B. If the number of N is larger than 2, the convex closure method, described above, may be used.

The behavior controller 440 controls the autonomous behavior of the robot apparatus 1, based on the mobility area map built by the mobility area recognition unit 430, so that the mobile robot apparatus 1 does not come out from e.g. the mobility area. Specifically, the behavior controller 440 builds an obstacle map and adds the landmarks, used for preparing the mobility area, to the obstacle map as virtual obstacles, in order to control the behavior of the robot apparatus so that the robot apparatus will move only through an area determined to be the mobility area in the obstacle map.

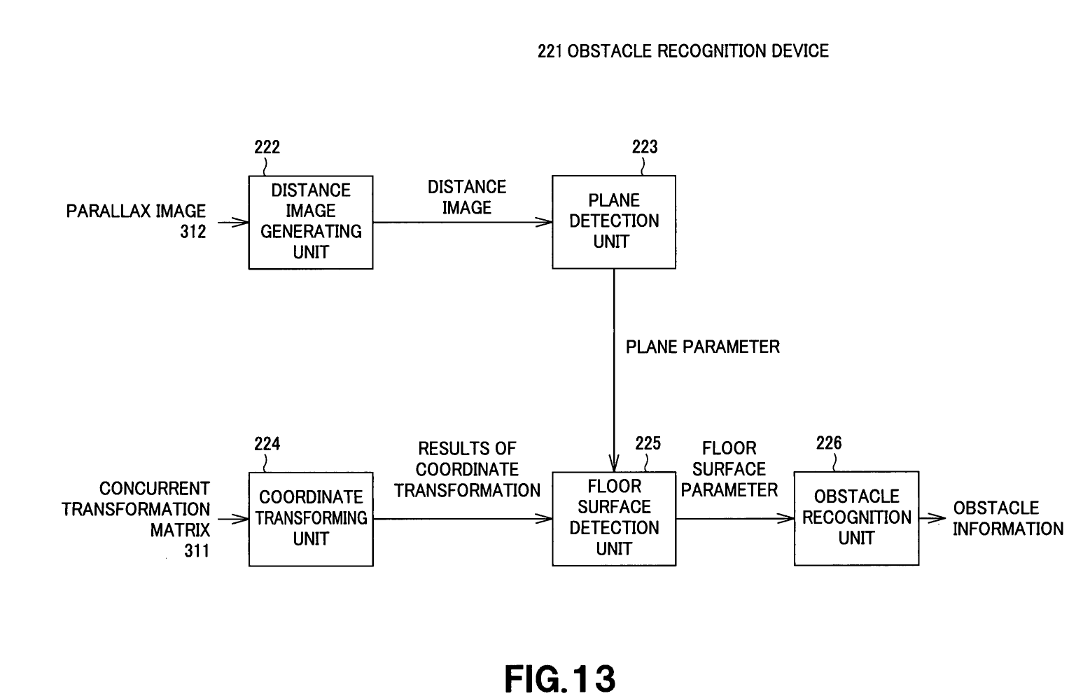

The obstacle map is prepared on the basis of the obstacle recognition technique disclosed in the Japanese Patent Application 2002-073388 by the present Assignee. This technique is now explained in detail. An obstacle recognition device 221 is constructed within a CPU 220 which implements PLEX320 shown in FIG. 4. Referring to the functional block diagram, shown in FIG. 13, the obstacle recognition device 221 is made up by a distance image generating unit 222, generating a distance image from a disparity image, a plane detection unit 223 calculating the plane parameters by plane detection from the distance image, a coordinate transforming unit 224 for performing coordinate transformation of the concurrent transformation matrix, a floor surface detection unit 225 for detecting the floor surface from the results of the coordinate transformation and the plane parameters, and an obstacle recognition unit 226 for recognizing an obstacle from the plane parameters on the floor surface.

The distance image generating unit 222 generates a distance image, using a concurrent transformation matrix corresponding to the disparity image, as calculated based on image data obtained from the two CCD cameras, provided to the robot apparatus 1, at the location of the two CCD cameras, based on the disparity image and a sensor data output obtained from plural sensor means provided to the robot apparatus 1. The plane detection unit 223 detects plane parameters, based on the distance image generated by the distance image generating unit 222. The coordinate transforming unit 224 transforms the concurrent transformation matrix into a coordinate on the touchdown surface of the robot apparatus 1. The floor surface detection unit 225 detects the floor surface, using the plane parameters from the plane detection unit 223 and the results of the coordinate transformation from the coordinate transforming unit 224, to send the plane parameters to the obstacle recognition unit 226. The obstacle recognition unit 226 selects a point resting on the floor surface, using the plane parameter of the floor surface as detected by the floor surface detection unit 225, and recognizes the obstacle, based on this point.

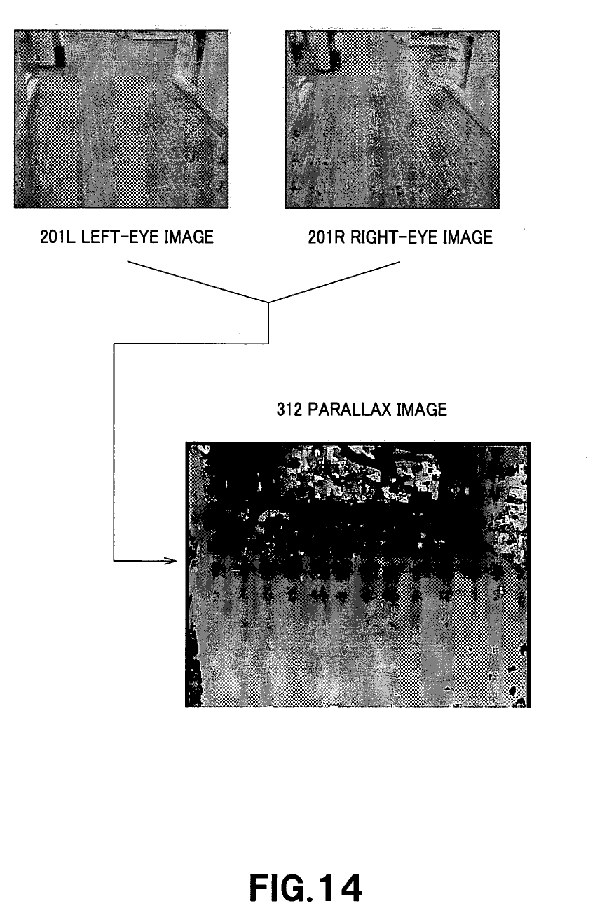

As described above, the image taken by the CCD cameras 200R, 200L is entered to the stereo image processing unit 210. From the parallax information (distance information) of the right eye image 201R and the left eye image 201L, shown in detail in FIG. 14, the color images (YUV) 202 and the disparity images (YDR) 203 are calculated and entered to the CPU 220. The sensor data 240 from plural sensors, provided to the robot apparatus 1, are also supplied. The image data 301, made up by the parallax information and the disparity image, and the sensor data 302, which are data such as joint angle data of the robot apparatus, are entered to the kinematic odometric unit KINE 310.

This kinematic odometric unit KINE 310 indexes the joint angle of the sensor data 302 at the time when the image of the image data 301 was photographed, based on the input data made up by the image data 301 and the sensor data 302 and, using the joint angle data, transforms the robot-centered coordinate system, having the robot apparatus 1 at the center, into the coordinate system of the cameras provided to the head unit. In the present embodiment, the concurrent transformation matrix 311 of the camera coordinate system is derived from the robot-centered coordinate system. This concurrent transformation matrix 311 and the corresponding disparity image 312 are output to the obstacle recognition device 221 (results of execution of the plane extractor PLEX 320).

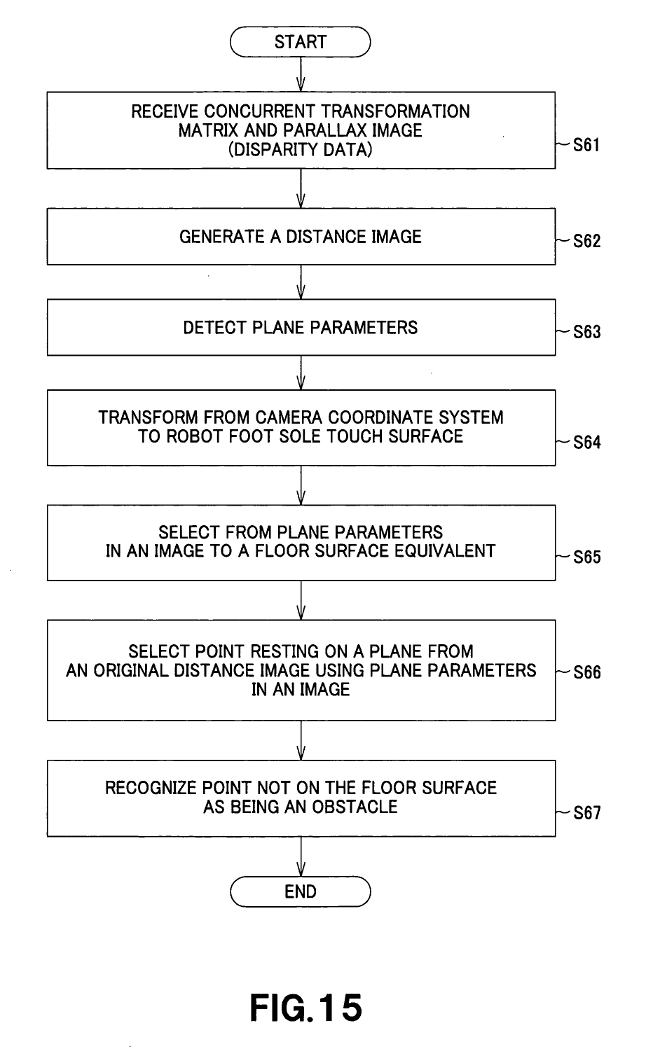

The obstacle recognition device 221 (plane extractor PLEX 320) receives the concurrent transformation matrix 311 and the corresponding disparity image 312 to recognize the obstacle in accordance with the processing sequence shown in FIG. 15.

First, the coordinate transforming unit 224 of the obstacle recognition device 221 (plane extractor PLEX 320) receives the concurrent transformation matrix 311, while the distance image generating unit 222 receives the disparity image 312 corresponding to the concurrent transformation matrix 311 (step S61). The distance image generating unit 222 exploits the calibration parameters, which have absorbed the lens distortion and the stereo mounting error from the disparity image 312, to generate three-dimensional position data (X, Y, Z), as seen from the camera coordinate, as a distance image, from pixel to pixel (step S62). Each three-dimensional position data individually owns reliability parameters, obtained e.g. from reliability in the input image, such as disparity image or distance image, and is sorted and input, based on this reliability parameter.

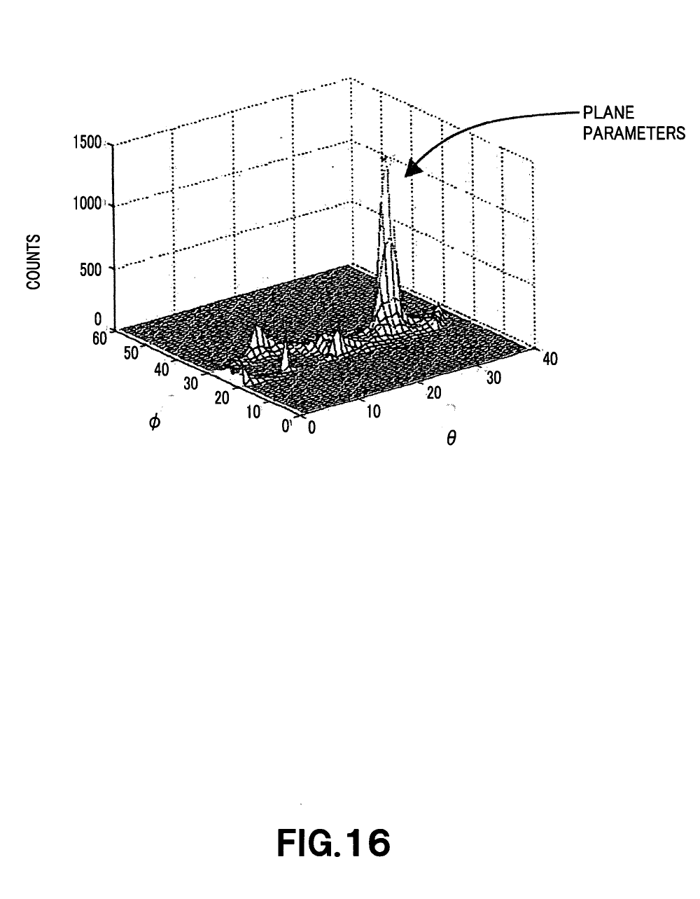

The plane detection unit 223 samples data at random from the sorted three-dimensional data to estimate the plane by Huff transform. That is, plane detection unit calculates plane parameters (θ, φ, d), with (θ, φ) being the orientation of a normal line vector and d being the distance from the point of origin, and directly votes the plane parameters to a voting space (θ, Ψ, d)=(θ, φ cos θ, d) to estimate the plane. In this manner, the plane detection unit 223 detects parameters of a plane predominant in an image (step S63). The plane parameters are detected by a histogram in the parameter space (θ, φ) (voting space) shown in FIG. 16. The parameters with small voting and with large voting may be deemed to indicate an obstacle and an article on the planar surface, respectively.

In voting, each vote is differentially weighted by different methods for calculating the reliability parameters or plane parameters ancillary to the three-dimensional data to provide for different vote values. Moreover, in estimating the peak value derived from the distribution of vote values, weighted averaging in the vicinity of the peak value, for example, may be carried out in order to estimate high reliability data. Using the plane parameters as initial parameters, iteration may be carried out to determine a plane in order to determine a plane with higher reliability. The processing on the downstream side may be facilitated by calculating the reliability of the plane, using the residual errors in iteration and reliability parameters attendant on the three-dimensional data from which the ultimately determined plane has been calculated, and by outputting the plane reliability along with the plane data. In this manner, plane extraction is achieved by a stochastic method of determining the parameters of the dominant plane contained in the three-dimensional data from the three-dimensional data by voting, that is, by estimation of the probability density function which is based on the histogram. With the use of the so produced plane parameters, it is possible to grasp the distance from the plane of the point of measurement of the distance originally obtained from the image.

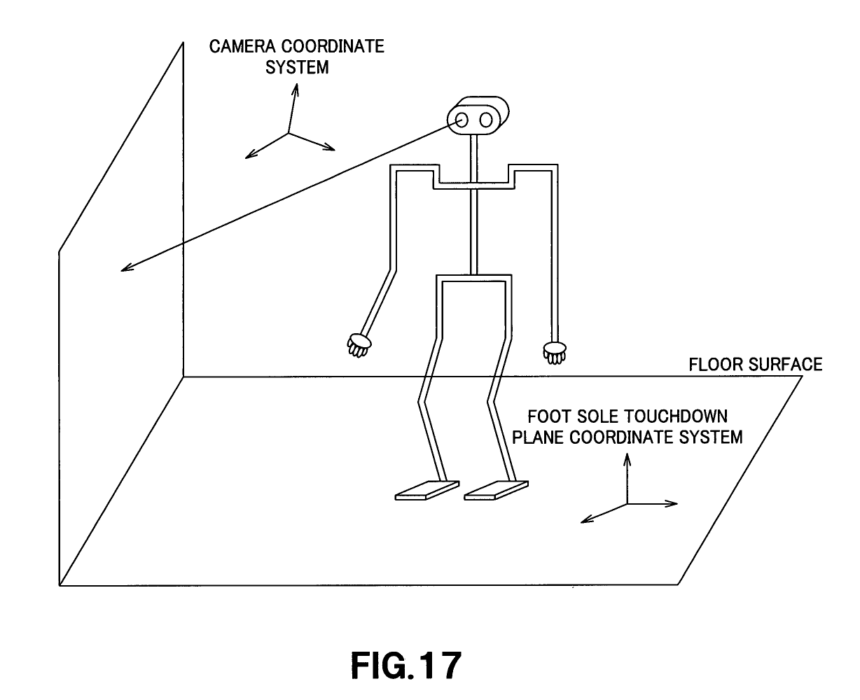

The coordinate transforming unit 224 then finds the conversion from the concurrent transformation matrix 311 of the camera coordinate system to the foot sole touchdown surface of the robot, as shown in FIG. 17 (step S64). This achieves calculations of the touchdown surface represented by the camera coordinate system. From the collation of the results of detection of the plane by an image in the step S63 by the plane detection unit 223, and from the collation of the foot sole touchdown surface by the coordinate transforming unit 224 in the above step S64, the floor surface detection unit 225 selects a plane equivalent to the floor surface from the plane parameters in the image (step S65).

The obstacle recognition unit 226 uses the plane parameters, selected in the step S65 by the floor surface detection unit 225, to select a point resting on the plane from the original distance image (step S66). For this selection, the fact that the distanced from the plane is smaller than a threshold value Dₜₕ is used.

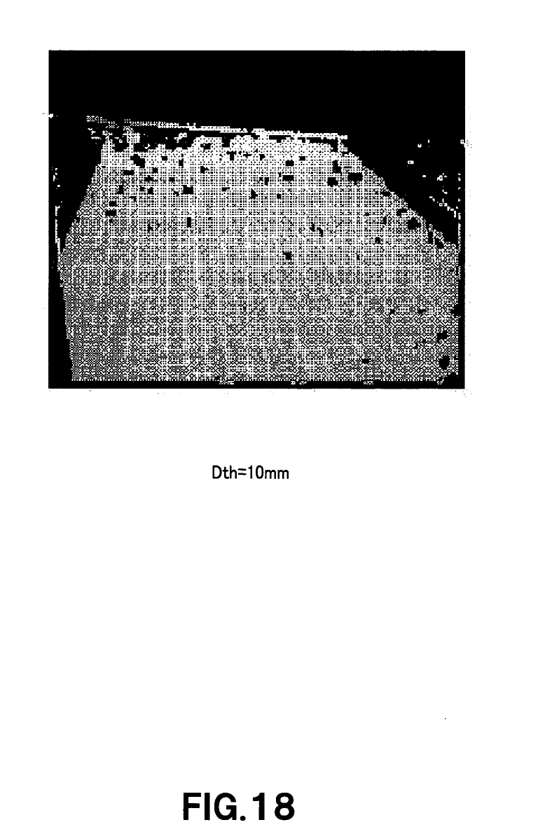

FIG. 18 shows a point of measurement (× mark) as selected for a range with the threshold value Dₜₕ of 1 cm. In FIG. 18, points indicated with black denote those not verified to be planar.

Hence, the obstacle recognition unit 226 in the step S67 may recognize that points other than those lying on a plane (floor surface), that is points not present on the floor surface, in the step S66, as being an obstacle. These results of check may be represented by the point (x, y) on the floor surface and its height z. If z<0, it indicates a point recessed from the planar surface.

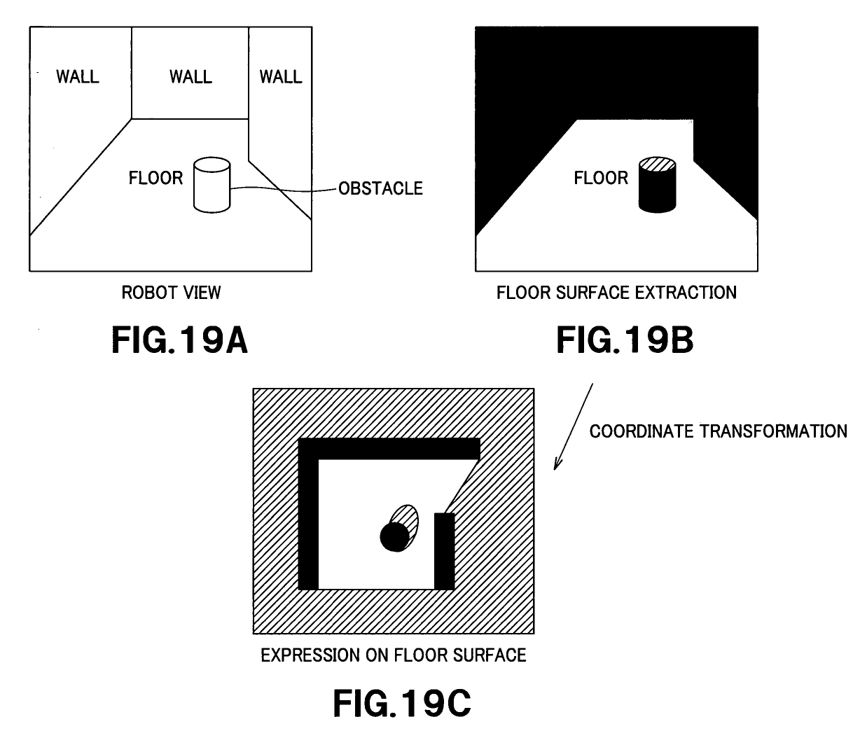

From this, such a decision may be given that a point of obstruction higher than a robot can be passed through by the robot, so that it is not an obstacle. Moreover, if coordinate transformation is made such that the height z of an image (FIG. 19B) extracted from the floor surface, as obtained form a robot view (FIG. 19A) is equal to 0 (Z=0), whether the image is the floor or an obstacle may be represented from the two-dimensional position on the planar surface, as shown in FIG. 19C.

In this manner, the obstacle recognition device is able to extract a stable plane in order to detect the plane using a large number of measured points. A correct plane may be selected by collating a plane candidate obtained from the image to floor surface parameters obtained from the robot posture. Since it is not the obstacle but in effect the floor surface, that is recognized, recognition not dependent on the shape or the size of the obstacle may be achieved. Since the obstacle is expressed by the distance from the floor surface, even fine steps or recesses may be detected. Such decision may be made for striding over or diving below the obstacle in consideration of the robot size. Since the obstacle is expressed as an obstacle lying on a two-dimensional floor surface, such a technique used in a mobile robot in a preexisting route schedule may be applied, while calculations may be faster than in case of three-dimensional obstacle expression.

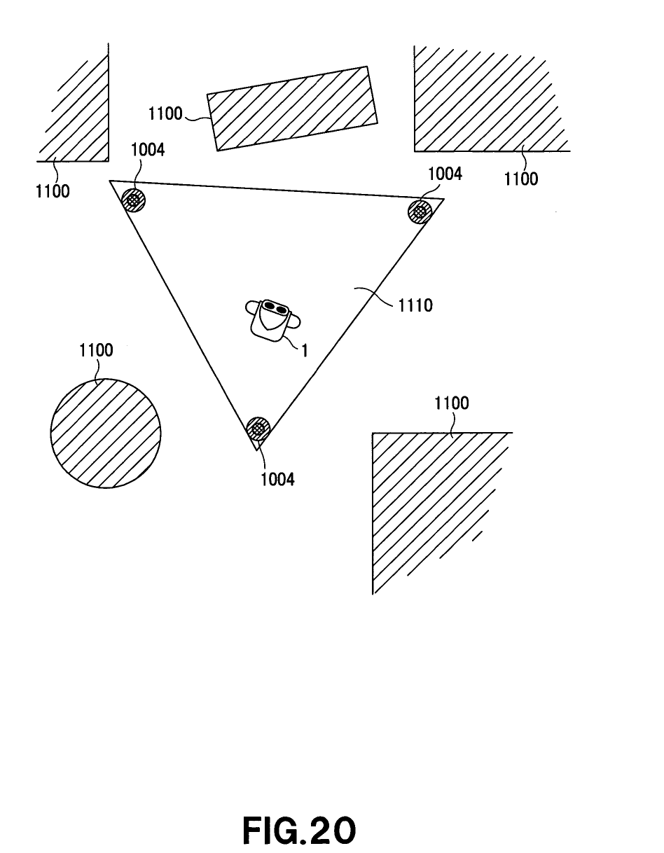

A specified example in which an obstacle map is prepared by the aforementioned obstacle recognition device, the mobility area map is added to the obstacle map as a virtual obstacle and behavior control is managed based on the obstacle map, is hereinafter explained. For example, such a specified example is now explained, in which the behavior of the robot apparatus 1 is controlled in an environment shown in FIG. 20, that is, in an environment in which three landmarks 1004 are arranged in a triangle as the landmarks are further surrounded by plural obstacles 1100.

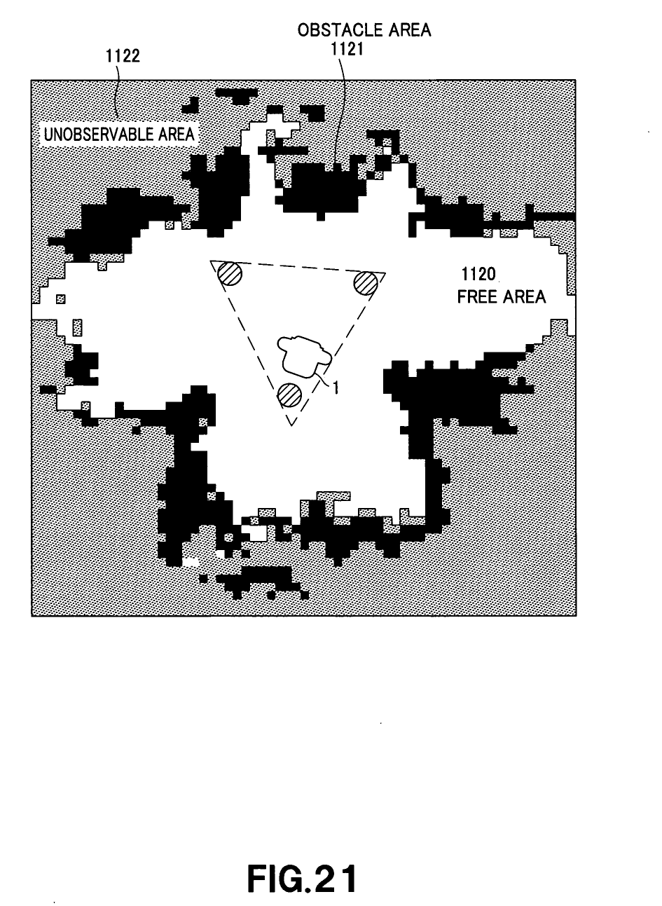

First, a behavior controlling apparatus builds, by the obstacle recognition device, an obstacle map of FIG. 21, holding the information on the mobility area and immobility area around the robot. In FIG. 21, an obstacle area 1121 corresponds to the obstacle 1100 in FIG. 20. A free area 1120 denotes an area where the robot apparatus 1 may walk, and an unobservable area 1122 denotes an area surrounded by the obstacles 1100 and which cannot be observed.

By exercising behavior control such that the robot apparatus 1 will walk only in the free area except in a mobility area 1110 delimited by the landmarks, the robot apparatus 1 is able to perform autonomous behavior without impinging against the obstacle.

The behavior controlling apparatus then adds the mobility area 1110, generated by the mobility area recognition unit 430, as a virtual obstacle to the obstacle map.

The behavior controlling apparatus then maps out a behavior schedule so that the robot apparatus moves in an area determined to be a mobility area, in the obstacle map in which the virtual obstacle has been added to the obstacle information, and accordingly performs behavior control.

In case the robot apparatus 1 is within the mobility area, it moves within this area. In case the robot apparatus 1 is outside the mobility area, its behavior is controlled so as to revert to within the mobility area.

Meanwhile, it is also possible for the behavior controlling apparatus to add a landmark, used by the mobility area recognition unit 430 for generating the mobility area 1110, to the obstacle map, as virtual obstacle, and to control the behavior of the robot apparatus so that the robot is moved only through the area determined to be a free area or a mobility area.

The behavior control following the setting of the mobility area is performed with the command by the user's speech as a trigger. For example, if a circle with a radius r[m] centered about a sole landmark is set, as shown in FIG. 12A, the behavior of the robot apparatus 1 is controlled in accordance with a command: ‘Be here or near here’. In case the mobility area is set by e.g. convex closure, the robot's behavior is controlled in accordance with a command such as ‘Play here’ or ‘Do not go out’. It is also possible to set the immobility area and to control the behavior in accordance with a command: ‘Do not enter here’.

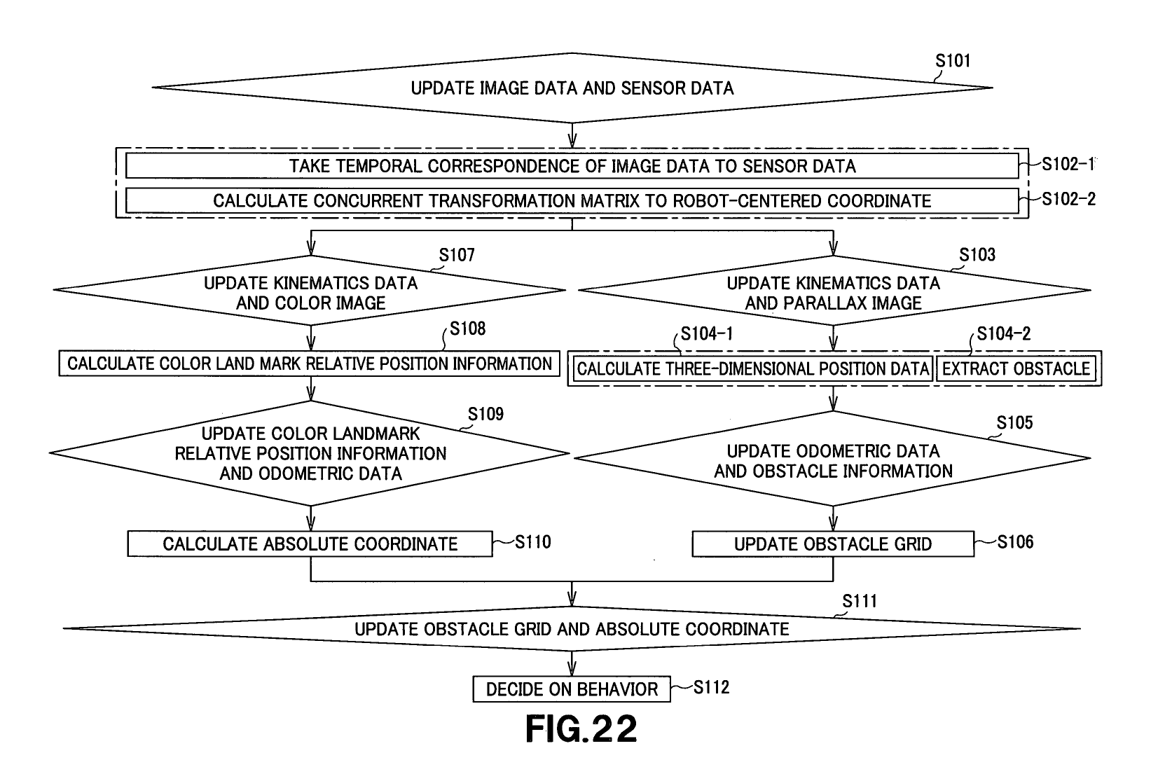

The software of the robot apparatus 1, shown in FIG. 4, is now explained in detail. FIG. 22 is a flowchart showing the movements of the software 300 shown in FIG. 4.

The kinematic odometric unit KINE 310 of the software 300, shown in FIG. 4, is supplied with the image data 301 and with the sensor data 302, as described above. The image data 301 is the color image and the disparity image by the stereo camera. The sensor data is data such as joint angles of the robot apparatus. The kinematic odometric unit KINE 310 receives these input data 301, 302 to update the images and the sensor data so far stored in the memory (step S101).

The image data 301 and the sensor data 302 are then temporally correlated with each other (step S102-1). That is, the joint angle of the sensor data 302 at the time of photographing of the image of the image data 301 is indexed. Using the data of the joint angle, the robot-centered coordinate system, centered about the robot apparatus 1, is transformed to a coordinate system of the camera provided to the head unit (step S102-2). In the present embodiment, the concurrent transformation matrix 311 of the camera coordinate system is derived from the robot-centered coordinate system. This concurrent transformation matrix 311 and the corresponding image data are transmitted to an object responsible for image recognition. That is, the concurrent transformation matrix 311 and the corresponding disparity image 312 are output to the plane extractor PLEX 320, while the concurrent transformation matrix 311 and the color image 313 are output to the landmark sensor CLS 340.

Moreover, the distance traversed by the robot apparatus 1 is calculated from the walking parameters obtained from the sensor data 302 and the counts of the number of steps from the foot sole sensor, in order to calculate the distance traversed by the robot apparatus 1 in the robot-centered coordinate system. The distance traversed in the robot-centered coordinate system is also termed the odometric data. This odometric data is output to the occupancy grid OG 330 and to the absolute coordinate calculating unit or localizer LZ 350.

When supplied with the concurrent transformation matrix 311, as calculated by the kinematic odometric unit KINE 310, and with the corresponding disparity image 312 as obtained from the stereo camera, the plane extractor PLEX 320 updates these data so far stored in the memory (step S103). Using e.g. the calibration parameters from the stereo camera, the plane extractor PLEX 320 calculates the three-dimensional position data (range data) (step S104-1). From this range data, planes other than those of the wall or tables are extracted as planes. From the concurrent transformation matrix 311, correspondence is taken of the plane contacted by the foot sole of the robot apparatus 1 to select the floor surface, and points not present on the floor surface, for example, the points lying at a height larger than a preset threshold value, is deemed to be an obstacle, and its distance from the floor surface is calculated. The obstacle information (obstacle) 321 is output to the occupancy grid OG 330 (step S104-2).

When supplied with the odometric data 314, calculated by the kinematic odometric unit KINE 310, and with the obstacle information (obstacle) 321 as calculated by the plane extractor PLEX 320, the occupancy grid OG 330 updates the data so far stored in the memory (step S105). The obstacle grid, holding the probability as to whether or not there is an obstacle on the floor surface, is updated by a stochastic technique (step S106).

The occupancy grid OG 330 holds the obstacle information in 4 meters (4 m) therearound, centered about the robot apparatus 1, that is, the aforementioned environmental map, and the posture information indicating the bearing of the robot apparatus 1. Thus, the occupancy grid OG 330 updates the environmental map by the above-described method and outputs the updated results of recognition (obstacle information 331) to map out a schedule for evading the obstacle in an upper layer, herein the behavior decision unit or situated behavior layer (SBL) 360.

When supplied with the concurrent transformation matrix 311 and with the color image 313 from the kinematic odometric unit KINE 310, the landmark sensor CLS 340 updates these data stored from the outset in the memory (step S107). The landmark sensor CLS 340 processes the color image 313 to detect a color land mark recognized in advance. The position and the size of the color land mark on the color image 313 are converted to the position of the camera coordinate system. Additionally, the concurrent transformation matrix 311 is used and the information of a color landmark position in the robot-centered coordinate system (relative color landmark position information) 341 is output to the absolute coordinate calculating unit LZ 350 (step S108).

When the absolute coordinate calculating unit LZ 350 is supplied with the odometric data 314 from the kinematic odometric unit KINE 310 and with the relative color landmark position 341 from the landmark sensor CLS 340, these data stored from the outset in the memory are updated (step S109). Using the absolute coordinate of the color landmark (position on the world coordinate system), relative color landmark position 341 and the odometric data, recognized in advance, the absolute coordinate calculating unit LZ 350 calculates the absolute coordinate of the robot apparatus (position in the world coordinate system) by a stochastic technique to output the absolute coordinate position 351 to a situated behavior layer (SBL) 360.

When the situated behavior layer (SBL) 360 is supplied with the obstacle information 331 and with the absolute coordinate position 351 from the occupancy grid OG 330 and from the absolute coordinate calculating unit LZ 350, respectively, these data stored in advance in the memory are updated (step S111). The situated behavior layer (SBL) 360 then acquires the results of recognition pertaining to the obstacles present about the robot apparatus 1, by the obstacle information 331 from the occupancy grid OG 330, while acquiring the current absolute coordinate of the robot apparatus 1 from the absolute coordinate calculating unit LZ 350, to generate a route on which the robot apparatus may walk to a target site provided on the absolute coordinate system or on the robot-centered coordinate system, without impinging on an obstacle. The situated behavior layer (SBL) 360 issues a movement command for executing the route, from one route to another, that is, determines the behavior the robot apparatus 1 is to perform, depending on the situation, from input data, to output the sequence of actions (step S112).

In the case of navigation by the human being, the occupancy grid OG 330 furnishes to the user the results of recognition pertaining to the obstacles present around the robot apparatus and the absolute coordinate of the current location of the robot apparatus from the absolute coordinate calculating unit LZ 350, and causes a movement command to be issued responsive to an input from the user.

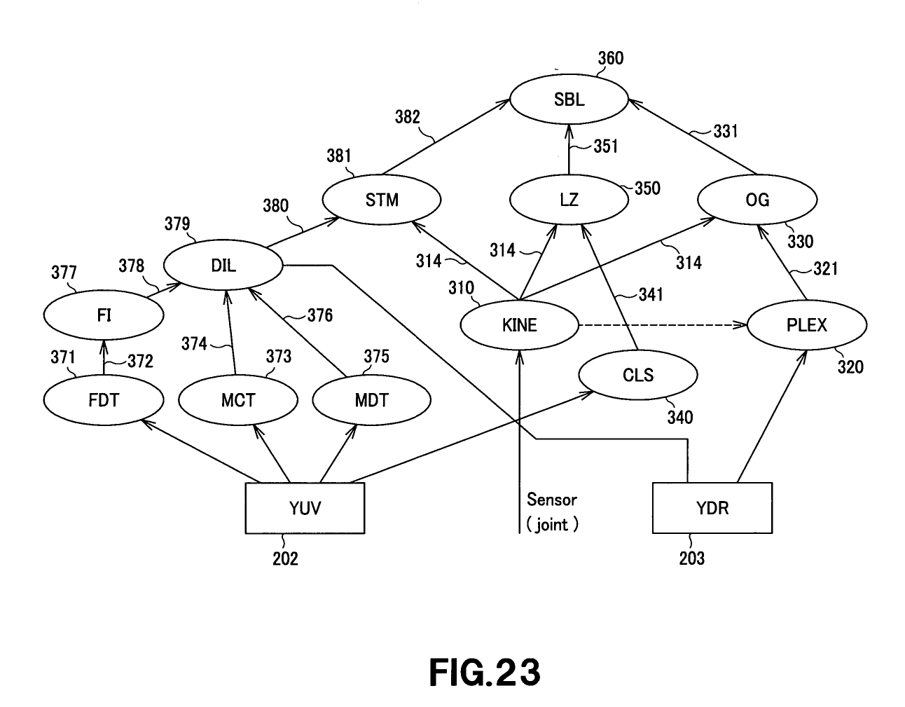

FIG. 23 schematically shows the flow of data input to the aforementioned software. In FIG. 23, the component parts which are the same as those shown in FIGS. 1 and 2 are depicted by the same reference numerals and are not explained in detail.

A face detector FDT 371 is an object for detecting a face area from an image frame, and receives the color image 202 from an image inputting device, such as a camera, to convert it to nine-state reduced-scale images. From all of these images, a rectangular area for a face is searched. The face detector FDT 371 discards overlapping candidate areas and outputs the information 372, such as position, size and features pertaining to the area ultimately determined to be a face, and sends the information to a face identifier FI 377.

The face identifier FI 377 is an object for identifying the detected face image by receiving the information 372, comprising a rectangular area image specifying the face area, from the face detector FDT 371, and for consulting a person dictionary stored in the memory to discriminate to whom in the person dictionary corresponds the face image. The face identifier FI 377 outputs the information on the location and the size of the human face area of the face image received from the face detector FDT 371 as well as the ID information 378 of the person in question to a distance information linker DIL 379.

A multi-color tracker MCT 373 (color recognition unit) is an object for making color recognition. It receives the color image 202 from an image inputting device, such as a camera, and extracts the color areas based on plural color model information it owns from the outset to split the image into plural areas. The multi-color tracker MCT 373 outputs the information, such as location, size or features 374, of the so split areas to the distance information linker DIL 379.

A motion detector MDT 375 detects a moving portion in an image, and outputs the information 376 of the detected moving area to the distance information linker DIL 379.

The distance information linker DIL 379 is an object for adding the distance information to the input two-dimensional information to output the three-dimensional information. It adds the distance information to the ID information 378 from the face identifier FI 377, the information 374 such as the location, size and the features of the split areas from the multi-color tracker MCT 373 and to the information 376 of the moving area from the motion detector MDT 375 to output the three-dimensional information 380 to a short-term memory STM 381.

The short-term memory STM 381 is an object for holding the information pertaining to the exterior environment of the robot apparatus 1 only for a shorter time. It receives the results of voice recognition (word, sound source direction and reliability) from an Arthur decoder, not shown, while receiving the location and the size of the skin-color area and the location and the size of the face area and receiving the ID information of a person from the face identifier FI 377. The short-term memory STM 381 also receives the ID information of a person from the face identifier FI 377, while receiving the neck direction (joint angle) of the robot apparatus from the sensors on the body unit of the robot apparatus 1. Using the results of recognition and the sensor output comprehensively, the short-term memory STM holds the information as to who is present in such and such place, who talked such and such speech and what dialog the robot apparatus had with such and such person. The short-term memory STM delivers the physical information concerning the object or target, and an event (hysteresis) along the temporal axis, as outputs to an upper module, such as behavior decision unit or situated behavior layer (SBL) 360.

The behavior decision unit SBL is an object for determining the behavior (situation dependent behavior) of the robot apparatus 1 based on the information from the short-term memory STM 381. The behavior decision unit SBL is able to evaluate and execute plural behaviors simultaneously. The behavior may be switched to start another behavior, with the body unit being in a sleep state.

The robot apparatus 1 of the type walking on two legs and controlled as to its behavior as described above, is now explained in detail. This humanoid robot apparatus 1 is a utility robot, supporting the human activities in various aspects of our everyday life, such as in our living environment, and is an entertainment robot capable not only of acting responsive to the inner states (such as anger, sadness, happiness or pleasure) but also of representing the basic movements performed by the human beings.

As described above, the robot apparatus 1 shown in FIG. 1 includes a body trunk unit 2, a head unit 3, connected to preset locations of the body trunk unit 2, left and right arm units 4R/L and left and right leg units 5R/L also connected to preset locations of the body trunk unit.

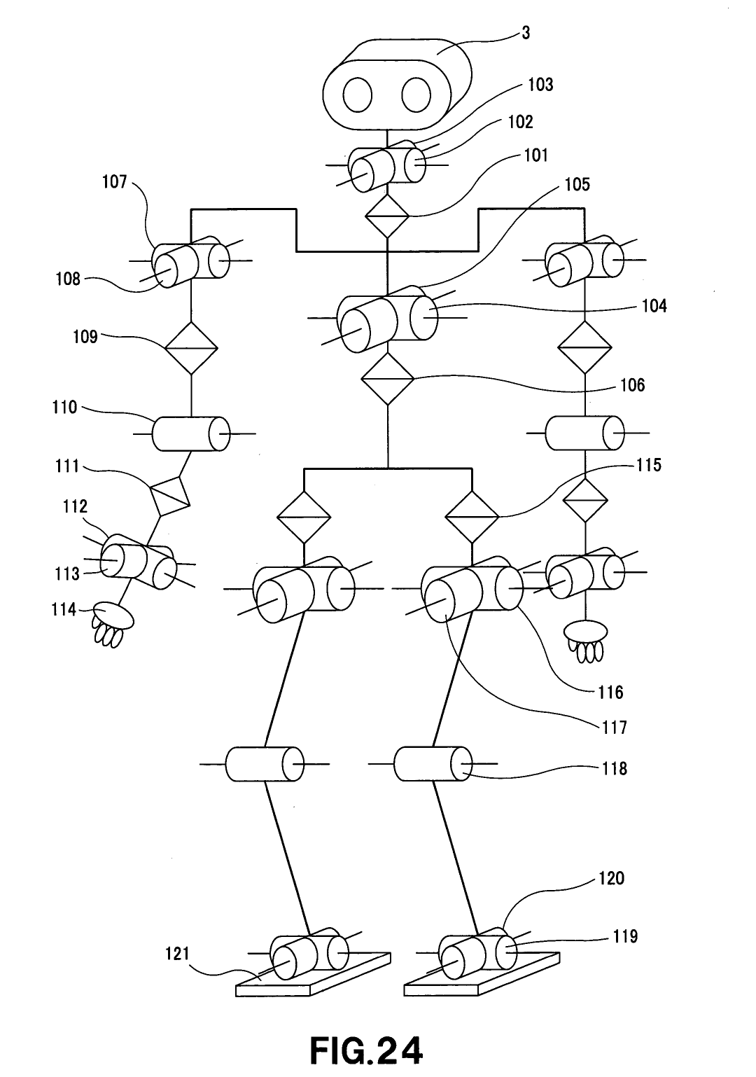

FIG. 24 schematically shows the structure of the degrees of freedom provided to the robot apparatus 1. The neck joint, supporting the head unit 3, has three degrees of freedom, namely a neck joint yaw axis 101, a neck joint pitch axis 102 and a neck joint roll axis 103.

The arm units 4R/L, forming the upper limbs, are each made up by a shoulder joint pitch axis 107, a shoulder joint roll axis 108, an upper arm yaw axis 109, an elbow joint pitch axis 110, a forearm yaw axis 111, wrist joint pitch axis 112, a wrist joint roll axis 113 and a hand part 114. The hand part 114 is, in actuality, a multi-joint multi-freedom degree structure including plural fingers. However, the hand unit 114 is assumed herein to be of zero degree of freedom because it contributes to the posture control or walking control of the robot apparatus 1 only to a lesser extent. Hence, each arm unit is assumed to have seven degrees of freedom.

The body trunk unit 2 has three degrees of freedom, namely a body trunk pitch axis 104, a body trunk roll axis 105 and a body trunk yaw axis 106.

The leg units 5R/L, forming the lower limbs, are each made up by a hip joint yaw axis 115, a hip joint pitch axis 116, a hip joint roll axis 117, a knee joint pitch axis 118, an ankle joint pitch axis 119, an ankle joint roll axis 120, and a foot unit 121. The point of intersection of the hip joint pitch axis 116 and the hip joint roll axis 117 is defined herein as the hip joint position. The foot unit 121 of the human body is, in actuality, a structure including the multi-joint multi-degree of freedom foot sole. However, the foot sole of the robot apparatus 1 is assumed to be of the zero degree of freedom. Hence, each leg part is formed by six degrees of freedom.

To summarize, the robot apparatus 1 in its entirety has 3+7×2+3+6×2=32 degrees of freedom. However, the robot apparatus 1 for entertainment is not necessarily restricted to 32 degrees of freedom, such that the degrees of freedom, that is, the number of joints, may be increased or decreased depending on constraint conditions imposed by designing or manufacture or requested design parameters.

In actuality, the degrees of freedom, provided to the robot apparatus 1, are mounted using an actuator. Because of the request for eliminating excessive swell in appearance to simulate the natural body shape of the human being, and for managing posture control for an instable structure imposed by walking on two legs, the actuator is desirably small-sized and lightweight.

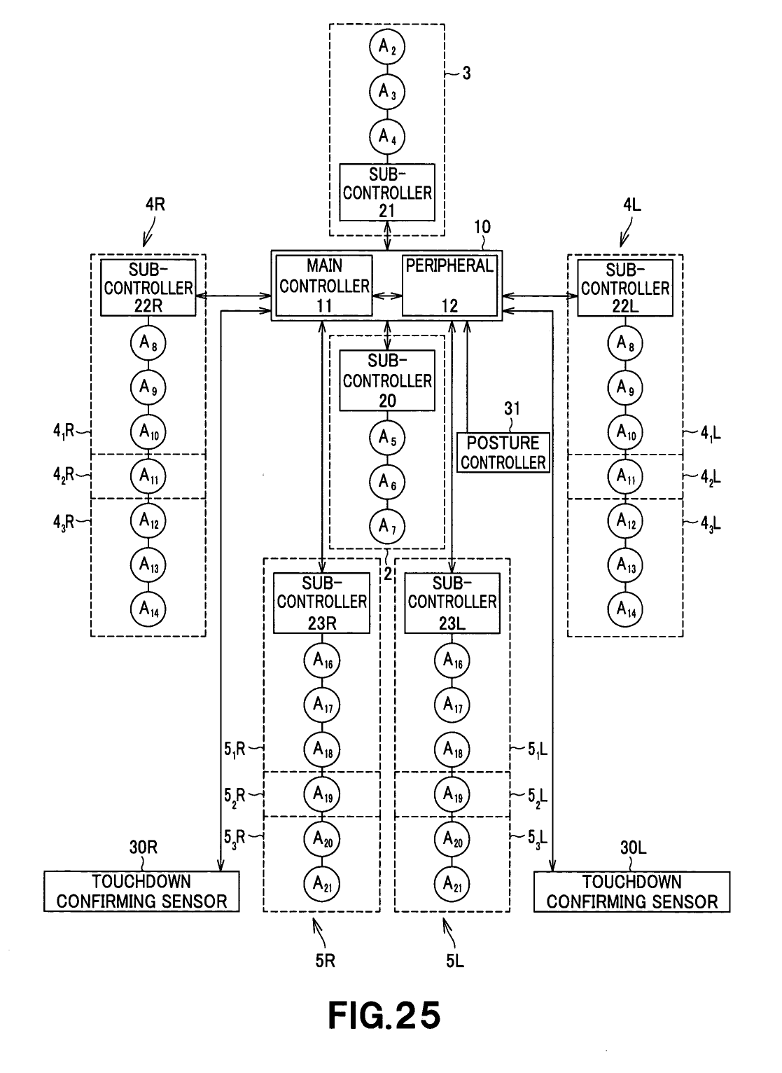

FIG. 25 schematically shows the control system structure of the robot apparatus 1. As shown in this figure, the robot apparatus 1 is made up by the body trunk unit 2, representing the four limbs of the human being, head unit 3, arm units 4R/L, leg units 5R/L and a control unit 10 for performing adaptive control for achieving converted movements of the respective units.

The overall movements of the robot apparatus 1 are comprehensively controlled by the control unit 10. This control unit 10 is made up by a main controller 11, including main circuit components, such as a central processing unit (CPU), not shown, a DRAM, not shown, or a flash ROM, also not shown, and a peripheral circuit, including an interface, not shown, for exchanging data or commands with respective components of the robot apparatus 1, and a power supply circuit, also not shown.

There is no particular limitation to the site for mounting the control unit 10. Although the control unit 10 is mounted in FIG. 25 to the body trunk unit 2, it may also be mounted to the head unit 3. Alternatively, the control unit 10 may be mounted outside the robot apparatus 1 and wired or wireless communication may be made between the body unit of the robot apparatus 1 and the control unit 10.

The degrees of freedom of the respective joints of the robot apparatus 1 shown in FIG. 25 may be implemented by associated actuators. Specifically, the head unit 3 is provided with a neck joint yaw axis actuator A₂, a neck joint pitch axis actuator A₃ and a neck joint roll axis actuator A₄ for representing the neck joint yaw axis 101, neck joint pitch axis 102 and the neck joint roll axis 103, respectively.

The head unit 3 includes, in addition to the CCD (charge coupled device) camera for imaging exterior status, a distance sensor for measuring the distance to a forwardly located article, a microphone for collecting external sounds, a loudspeaker for outputting the speech and a touch sensor for detecting the pressure applied by physical actions from the user, such as ‘stroking’ or ‘patting’.

The body trunk unit 2 includes a body trunk pitch axis actuator A₅, a body trunk roll axis actuator A₆ and a body trunk yaw axis actuator A₇ for representing the body trunk pitch axis 104, body trunk roll axis 105 and the body trunk yaw axis 106, respectively. The body trunk unit 2 includes a battery as a startup power supply for this robot apparatus 1. This battery is a chargeable/dischargeable battery.

The arm units 4R/L are subdivided into upper arm units 41R/L, elbow joint units 42R/L and forearm units 43R/L. The arm units 4R/L are provided with a shoulder joint pitch axis actuator A₈, a shoulder joint roll axis actuator A₉, an upper arm yaw axis actuator A₁₀, an elbow joint pitch axis actuator A₁₁, an elbow joint roll axis actuator A₁₂, a wrist joint pitch axis actuator A₁₃, and a wrist joint roll axis actuator A₁₄, representing the shoulder joint pitch axis 107, shoulder joint roll axis 108, upper arm yaw axis 109, elbow joint pitch axis 110, forearm yaw axis 111, wrist joint pitch axis 112 and the wrist joint roll axis 113, respectively.

The leg units 5R/L are subdivided into thigh units 51R/L, knee units 52R/L and shank units 53R/L. The leg units 5R/L are provided with a hip joint yaw axis actuator A₁₆, a hip joint pitch axis actuator A₁₇, a hip joint roll axis actuator A₁₈, a knee joint pitch axis actuator A₁₉, an ankle joint pitch axis actuator A₂₀ and an ankle joint roll axis actuator A₂₁, representing the hip joint yaw axis 115, hip joint pitch axis 116, hip joint roll axis 117, knee joint pitch axis 118, ankle joint pitch axis 119 and the ankle joint roll axis 120, respectively. The actuators A₂, A₃, . . . are desirably each constructed by a small-sized AC servo actuator of the direct gear coupling type provided with a one-chip servo control system loaded in the motor unit.

The body trunk unit 2, head unit 3, arm units 4R/L and the leg units 5R/L are provided with sub-controllers 20, 21, 22R/L and 23R/L of the actuator driving controllers. In addition, there are provided touchdown confirming sensors 30R/L for detecting whether or not the foot soles of the leg units 5R/L have touched the floor. Within the body trunk unit 2, there is provided a posture sensor 31 for measuring the posture.

The touchdown confirming sensors 30R/L are formed by, for example, proximity sensors or micro-switches, provided e.g. on the foot soles. The posture sensor 31 is formed e.g. by the combination of an acceleration sensor and a gyro sensor.

Based on outputs of the touchdown confirming sensors 30R/L, it may be verified whether the left and right legs are in the stance state or in the flight state during the walking or running movements. Moreover, the tilt or the posture of the body trunk may be detected by an output of the posture sensor 31.

The main controller 11 is able to dynamically correct the control target responsive to outputs of the sensors 30R/L, 31. Specifically, the main controller 11 performs adaptive control of the sub-controllers 20, 21, 22R/L and 23R/L to realize a full-body kinematic pattern in which the upper limbs, body trunk and the lower limbs are actuated in a concerted fashion.

As for the full-body movements on the body unit of the robot apparatus 1, the foot movements, the ZMP (zero moment point) trajectory, body trunk movement, upper limb movement or the height of the waist part, are set, and a command for instructing the movements in keeping with the setting contents is transferred to the sub-controllers 20, 21, 22R/L and 23R/L. These sub-controllers interpret the command received from the main controller 11 to output driving control signals to the actuators A₂, A₃, . . . . The ZMP means a point on the floor surface in which the moment by the force of reaction from the floor on which walks the robot apparatus becomes zero. The ZMP trajectory means the trajectory along which the ZMP travels during the period of walking movement of the robot apparatus 1. Meanwhile, the ZMP and use of the ZMP in the stability discrimination standard of the walking robot are explained in Miomir Vukobratovic, “Legged Locomotion Robots” (translated by Ichiro KATO et al., “Walking Robot and Artificial Leg”, issued by NIKKAN KOGYO SHIMBUM-SHA.

As described above, the sub-controllers interpret the command received from the main controller 11 to output driving control signals to the A₂, A₃, . . . to control the driving of the respective units. This allows the robot apparatus 1 to transfer in stability to the target posture to walk in a stable posture.

The control unit 10 in the robot apparatus 1 performs not only the aforementioned posture control but also comprehensive processing of various sensors, such as acceleration sensor, touch sensor or touchdown confirming sensors, the image information from the CCD cameras and the voice information from the microphone. In the control unit 10, the sensors, such as acceleration sensor, gyro sensor, touch sensor, distance sensor, microphone or loudspeaker, various actuators, CCD cameras or batteries are connected via hubs to the main controller 11.

The main controller 11 sequentially takes in sensor data, image data and voice data, supplied from the respective sensors, to sequentially store the data via internal interface in preset locations in a DRAM. The sensor data, image data, voice data and the residual battery capacity data, stored in the DRAM, are used when the main controller 11 performs movement control of the robot apparatus 1.

Initially, on power up of the robot apparatus 1, the main controller 11 reads out the control program for storage in the DRAM. The main controller 11 also checks the own and surrounding state and whether or not there has been any command or action from the user, based on the sensor data, image data, voice data or the residual battery capacity data, sequentially stored from the main controller 11 to the DRAM, as described above.

Moreover, the main controller 11 determines the behavior responsive to the own status, based on the results of check and the control program stored in the DRAM to cause the robot apparatus 1 to perform the behavior such as ‘body gesture’ or ‘hand gesture’.

In this manner, the robot apparatus 1 checks the own and surrounding status, based on the control program, to act autonomously responsive to the command and the action from the user.

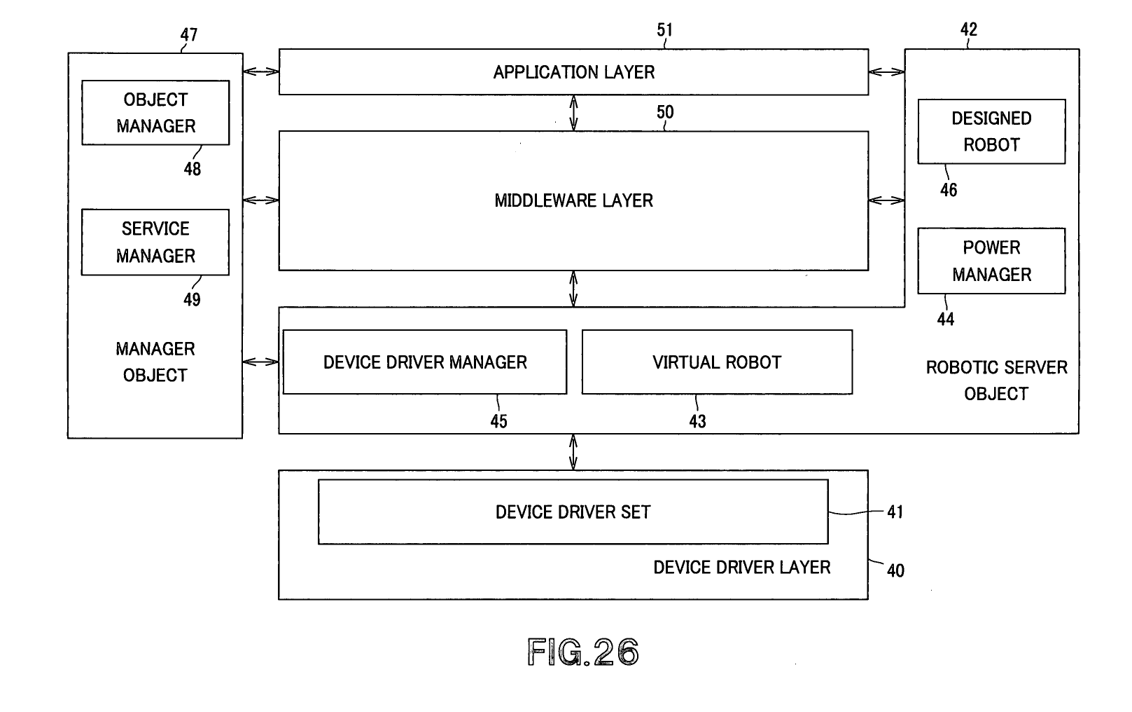

Meanwhile, this robot apparatus 1 is able to act autonomously, responsive to the inner status. An illustrative software structure in the robot apparatus 1 is now explained with reference to FIGS. 26 to 31. It is noted that the control program is pre-stored in the flash ROM 12, and is read out initially on power up of the robot apparatus 1.

In FIG. 26, a device driver layer 40 is located in the lowermost layer of the control program, and is made up by a device driver set 41, made up by plural device drivers. In this case, each device driver is an object allowed to have direct access to the hardware used in a routine computer, such as a CCD camera or timer, and performs processing responsive to an interrupt from an associated hardware.

A robotics server object 42 is located in the lowermost layer of the device driver layer 40, and is made up by a virtual robot 43, formed by a set of software providing an interface for accessing the hardware such as the aforementioned sensors or actuators 28₁s, to 28ₙ, a power manager 44, formed by a set of software supervising the switching of the power supply units, a device driver manager 45 formed by a set of software supervising other various device drivers, and a designed robot 46 formed by a set of software supervising the mechanism of the robot apparatus 1.

A manager object 47 is made up by an object manager 48 and a service manager 49. The object manager 48 is a set of software supervising the booting and end of the software set contained in the robotics server object 42, a middleware layer 50 and an application layer 51, while the service manager 49 is a software set supervising the connection of the respective objects based on the connection information of the objects stated in the connection file stored in the memory card.

The middleware layer 50 is located in the upper layer of the robotics server object 42, and is formed by a software set furnishing the basic functions of the robot apparatus 1, such as image or speech processing. The application layer 51 is located in the upper layer of the middleware layer 50 and is formed by a set of software determining the behavior of the robot apparatus 1 based on the results of processing by the software set forming the middleware layer 50.

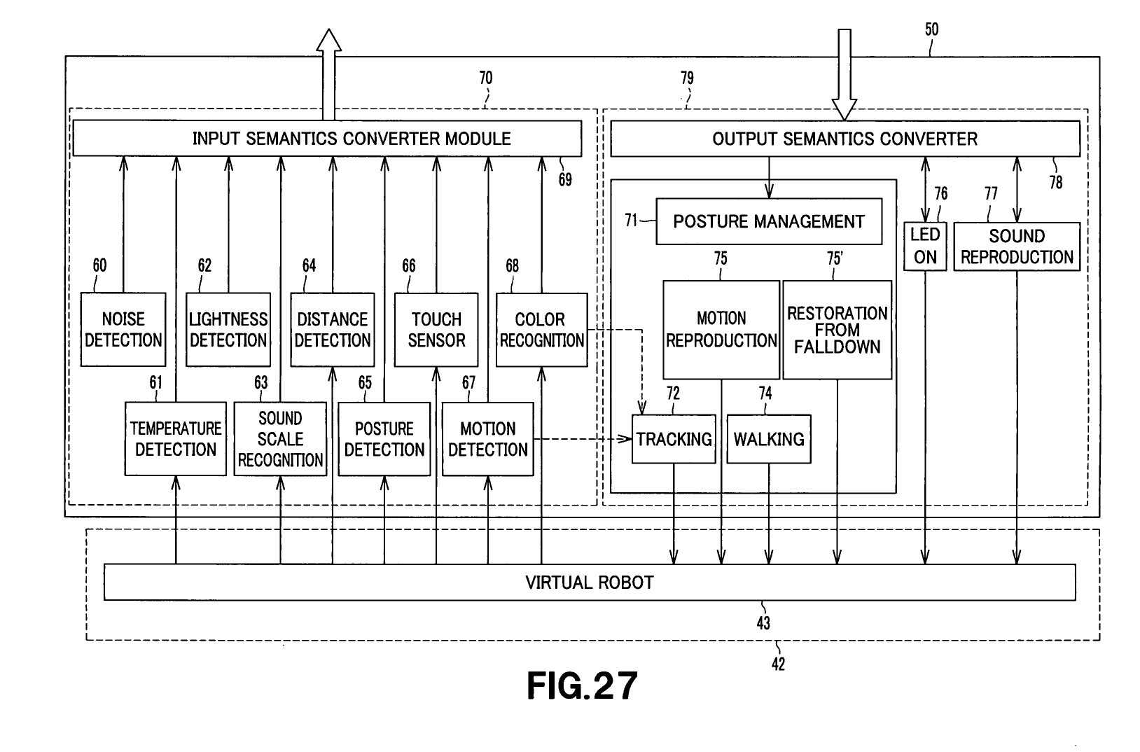

The specified software structures of the middleware layer 50 and the application layer 51 are shown in FIG. 27.

Referring to FIG. 27, the middleware layer 50 is made up by a recognition system 70 including signal processing modules 60 to 68 for noise detection, temperature detection, sound scale recognition, distance detection, posture detection, touch sensor, motion detection and color recognition, and an input semantics converter module 69, an output semantics converter module 70, and by an output system 79 including signal processing modules 71 to 77 for posture control, tracking, motion reproduction, walking, restoration from falldown, LED turn-on and sound reproduction.

The signal processing modules 60 to 68 of the driving system 70 takes in relevant data from among the sensor data, image data and the voice data, read out from the DRAM by the virtual robot 43 of the robotics server object 42, and performs preset processing on the so taken data to send the results of the processing to the input semantics converter module 69. The virtual robot 43 is constructed as a signal exchanging or converting section under the preset communication protocol.

Based on the results of processing supplied from these signal processing modules 60 to 68, the input semantics converter module 69 recognizes the own and surrounding states, such as ‘bothersome’, ‘hot’, ‘light’, ‘a ball is detected’, ‘falldown is detected’, ‘patted’, ‘hit’, ‘do-mi-so sound scale heard’, ‘a moving object has been detected’ or ‘an obstacle has been detected’, commands or actions from the user, and outputs the results of recognition to the application layer 51.

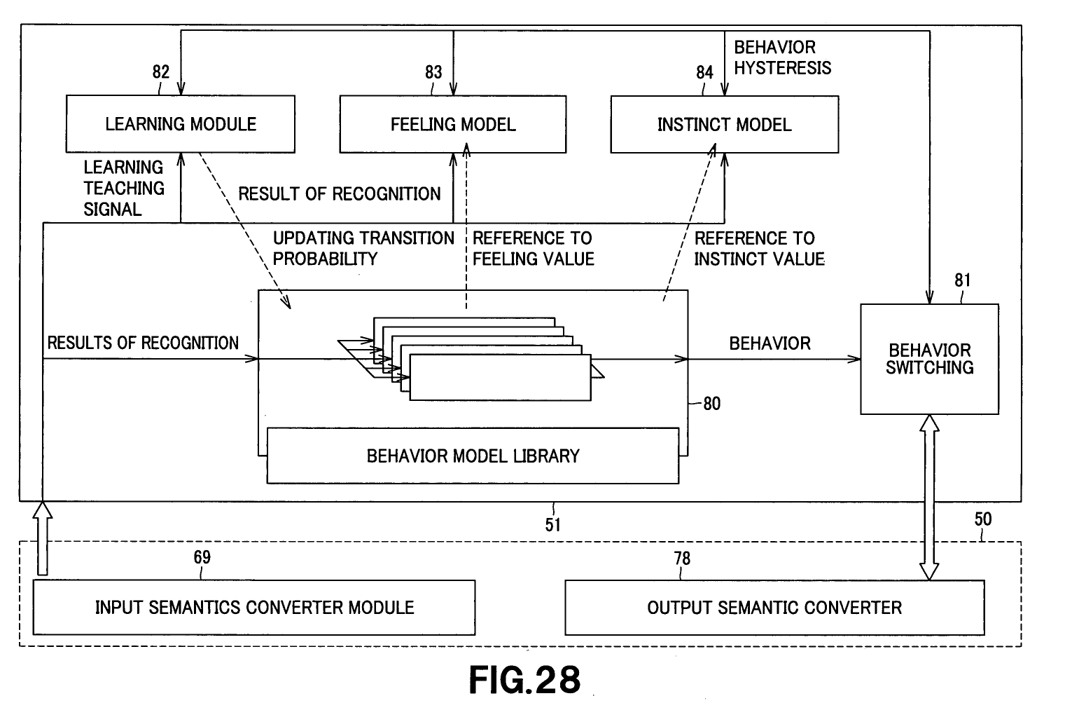

The application layer 51 is made up by five modules, namely a behavior model library 80, a behavior switching module 81, a learning module 82, a feeling model 83 and an instinct module 84, as shown in FIG. 28.

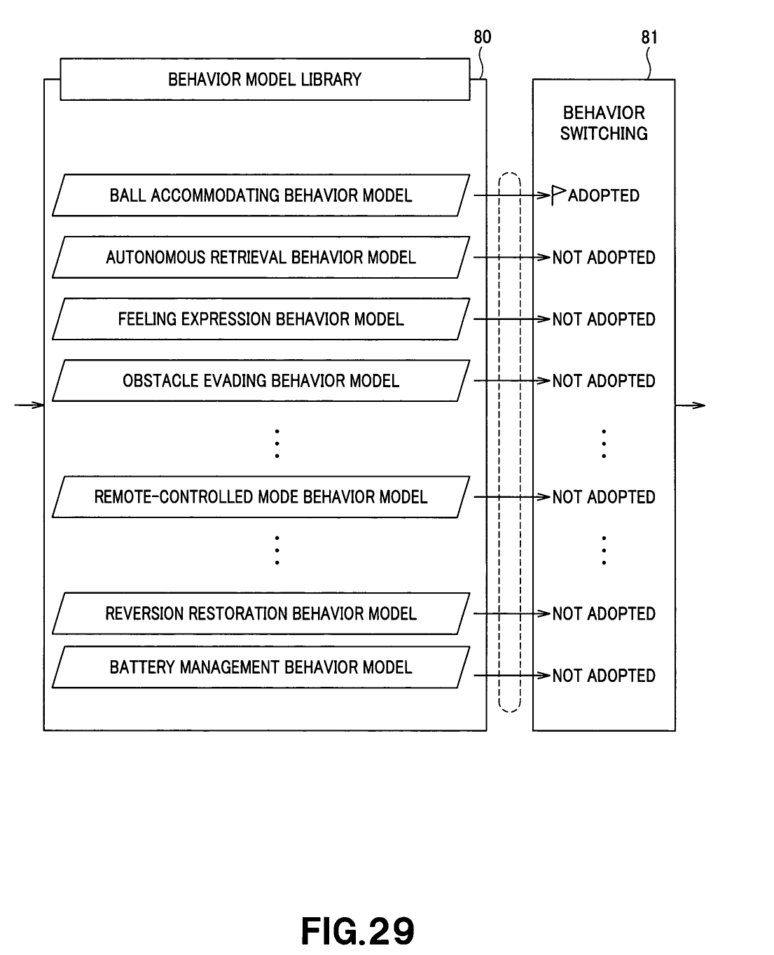

The behavior model library 80 is provided with independent behavior models, in association with pre-selected several condition items, such as ‘residual battery capacity is depleted’, ‘reversion from falldown’, ‘an obstacle is to be evaded’, ‘feeling is to be expressed’ and ‘a bal has been detected,’ as shown in FIG. 29.

When the results of recognition are supplied from the input semantics converter module 69 or a preset time has elapsed as from the time of supply of the last result of recognition, the behavior models refer to emotional parameter values held in the feeling model 83 as necessary, as later explained, or to the parameter values of the desire held in the instinct module 84, to determine the next following behavior, and outputs the results of the determination to the behavior switching module 81.

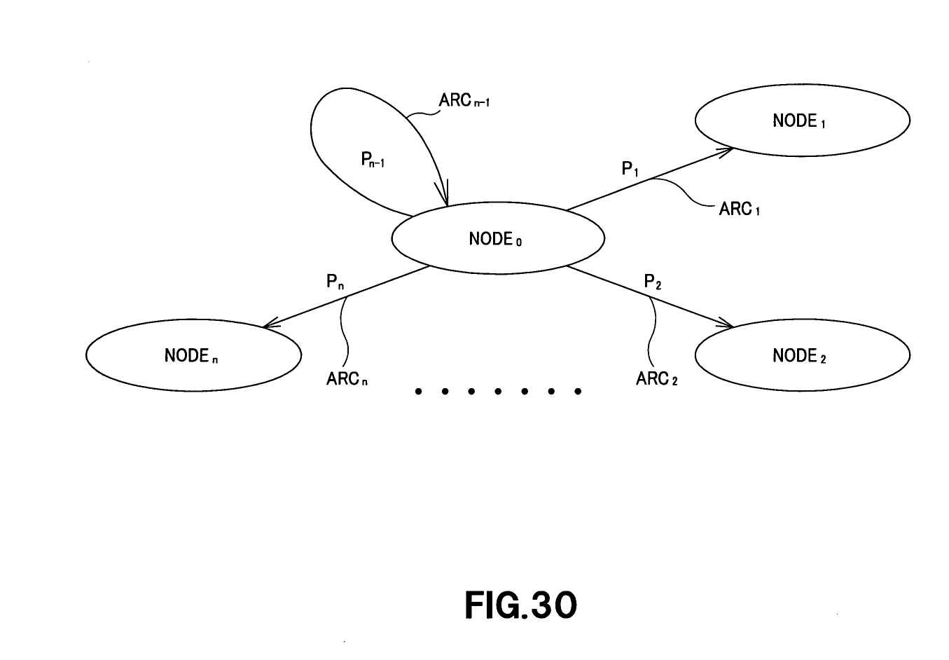

In the present embodiment, each behavior model uses an algorithm, termed a finite probability automaton, as the technique of determining the next behavior. This technique stochastically determines to which one of the nodes NODE₀ to NODEₙ transition is to be made from another of these nodes shown in FIG. 30 based on the transition probability P₁ to Pₙ as set for arcs ARC₁ to ARCₙ₁ interconnecting the nodes NODE₀ to NODEₙ, as shown in FIG. 30.

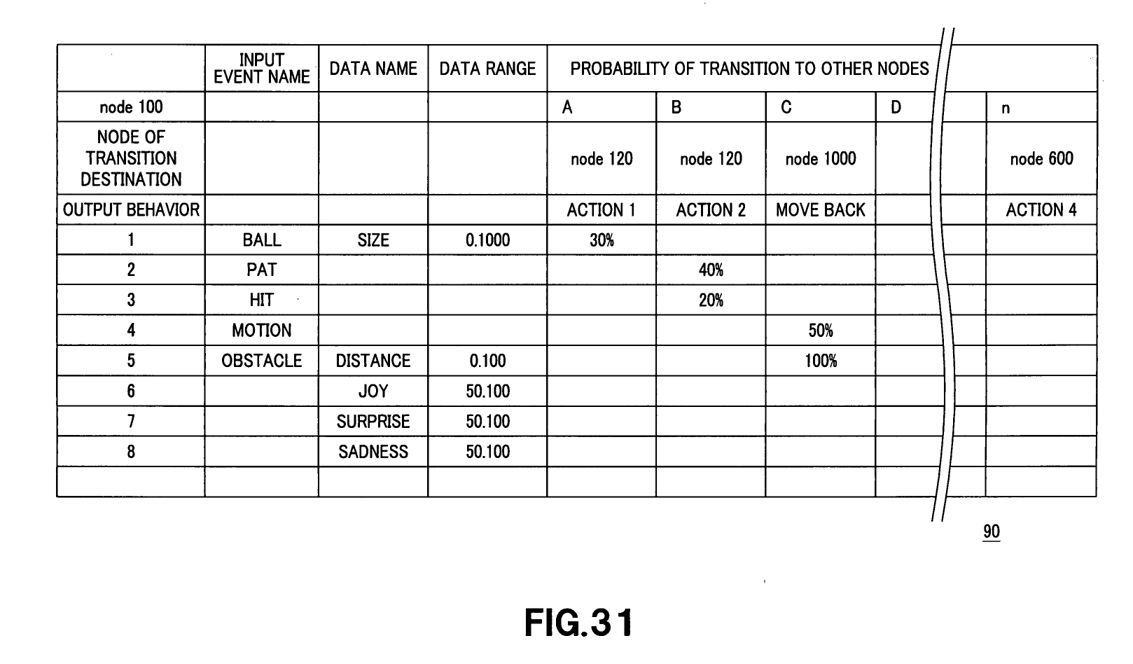

Specifically, each behavior model has a status transition table 90, shown in FIG. 31, for each of the nodes NODE₀ to NODEₙ, in association with the nodes NODE₀ to NODEₙ forming the own behavior models.

In this status transition table 90, the input events (results of recognition) as the transition conditions for the nodes NODE₀ to NODEₙ, are entered in a column ‘names of input events’ in the order of the priority sequence, and further conditions for the transition conditions are entered in an associated row of the columns of the ‘data names’ and ‘data range’.

Thus, in a node NODE₁₀₀, shown in the status transition table 90 of FIG. 31, the condition for transition to another node when the result of recognition ‘a ball has been detected (BALL)’ is given is that the ‘size’ of the ball supplied along with the results of recognition ranges between ‘0 and 1000’, while the same condition when the result of recognition ‘an obstacle has been detected (OBSTACLE)’ is given is that the ‘distance’ to the obstacle, supplied along with the results of recognition, ranges between ‘0 and 100’.

Moreover, if, in this node NODE₁₀₀, the result of recognition is not entered, but one of the parameters ‘joy’, ‘surprise’ or ‘sadness’ held by the feeling model 83, from among the parameters of the emotion and the desire held by the feeling model 83 and the instinct module 84, periodically referred to by the behavior model, ranges from ‘50 to 100’ transition to another node becomes possible.

In addition, in the status transition table 90, the names of the nodes, to which transition may be made from the nodes NODE₀ to NODEₙ, are entered in the row ‘nodes of transition destination’ in the column ‘probability of transition to other nodes’. The probability of transition to the other nodes NODE₀ to NODEₙ, to which transition may be made when all of the conditions stated in the columns ‘names of input events’, ‘data names’ and ‘data range’ are in order, are entered in the relevant cells of the column ‘probability of transition to the other nodes’, and the behavior to be output in case of transition to the nodes NODE₀ to NODEₙ is entered in the row ‘output behavior’ in the column ‘probability of transition to the other nodes’. Meanwhile, the sum of the probabilities of the respective rows in the column ‘probability of transition to the other nodes’ is 100%.

Thus, in the node NODE₁₀₀ represented by the status transition table 90, shown in FIG. 31, in case the result of recognition that a ‘ball has been detected (BALL)’ and ‘the ball has a size of ‘0 to 1000’ is given, transition may be made to a ‘node NODE₁₂₀ (node 120)’ with a probability of 30%, and the behavior ‘ACTION1’ is output at this time.

Each behavior model is constructed by interconnection of the nodes NODE₀ to NODEₙ, stated as the status transition table 90, such that, when the result of recognition is supplied from the input semantics converter module 69, the next behavior is stochastically determined by exploiting the status transition table of the corresponding nodes NODE₀ to NODEₙ, to output the result of decision to the behavior switching module 81.

With the behavior switching module 81, shown in FIG. 29, a behavior output from one of the behavior models of the behavior model library 80 which ranks high in a preset priority sequence is selected, and a command to execute the behavior, referred to below as a behavior command, is sent to an output semantics converter module 78 of the middleware layer 50. In the present embodiment, the lower the site of entry of the behavior model in FIG. 30, the higher is the rank of the behavior model in the priority sequence.

Based on the behavior completion information, given from the output semantics converter module 78, following the completion of the behavior, the behavior switching module 81 notifies the effect of the completion of the behavior to the learning module 82, feeling model 83 and to the instinct module 84.

The learning module 82 is supplied with the result of recognition of the teaching received as an action from the user, such as ‘being patted’ or ‘being stroked’, from among the results of recognition supplied from the input semantics converter module 69.

Based on the results of recognition and the notification received from the behavior switching module 71, the learning module 82 changes the corresponding transition probability of the associated behavior model in the behavior model library 70 so that, for ‘patted (scolded)’ and for ‘stroked (praised)’, the probability of the occurrence of the behavior is lowered and raised, respectively.

On the other hand, the feeling model 83 holds parameters, representing the intensity of the emotion, for each of six emotions ‘joy’, ‘sadness’, ‘anger’, ‘surprise’, ‘disgust’ and ‘fear’. The feeling model 83 periodically updates the parameter values of these emotions, based on the specified results of recognition such as ‘being patted’ or ‘stroked’ supplied from the input semantics converter module 69, time elapsed or on the notification from the behavior switching module 81.

Specifically, with the amount of variation of the emotion ΔE[t], as calculated by a preset formula based on the results of recognition supplied from the input semantics converter module 69, the behavior of the robot apparatus 1 and time elapsed since last update event, the current parameter value of the emotion E[t], and with the coefficient ke representing the sensitivity of the emotion, the parameter value of the emotion at the next period E[t+l] is calculated by the following equation (1):

E=[t+1]=E=[t]+ke×ΔE

and the so calculated parameter value is substituted for the current parameter value of the emotion E[t] to update the parameter value of the emotion. The feeling model 83 also update the parameter values of all of the emotions in similar manner.

It is predetermined to what extent the results of recognition or the notification from the output semantics converter module 78 influences the amount of variation of the emotion ΔE[t] of each emotion, such that the result of recognition of ‘being hit’ appreciably influences the amount of variation of the emotion ΔE[t] of the emotion ‘anger’, while the result of recognition of ‘being stroked’ appreciably influences the amount of variation of the emotion ΔE[t] of the emotion [joy].

The notification from the output semantics converter module 78 is the so-called feedback information of the behavior (behavior completion information) and is also the information of the result of the behavior realization. The feeling model 83 changes the feeling by this information. For example, the feeling level of the anger is lowered by the behavior of ‘shouting’. Meanwhile, the notification from the output semantics converter module 78 is also supplied to the learning module 82, which then changes the corresponding transition probability of the behavior model, based on this notification.

The feedback of the results of the behavior may also be by an output of the behavior switching module 81 (behavior seasoned with feeling).

The instinct module 84 holds parameters, specifying the intensity of each of four desires of exercise, affection, appetite and curiosity. The instinct module 84 periodically updates the parameter values of these desires based on the results of recognition accorded from the input semantics converter module 69, time elapsed and on the notification from the behavior switching module 81.

Specifically, as for the desires of exercise, affection and curiosity, with the amount of variation of the desire ΔI[k], as calculated on the basis of the results of recognition, time elapsed and the notification from the output semantics converter module 78, in accordance with a preset formula, the current parameter value of the desire I[k] and with a coefficient k₁ representing the sensitivity of the desire k₁, the parameter value I[k+l] of the desire in the next period is calculated, at a preset period, using the following equation (2):

I[k+1]=I[k]+ki×ΔI[k]

to update the parameter value of the desire by substituting the result of the calculations for the current parameter value of the desire. In similar manner, the instinct module 84 updates the parameter values of the respective desires excluding the ‘appetite’.

Meanwhile, it is predetermined to what extent the results of recognition or the notification from the output semantics converter module 78 influence the amount of variation of the emotion ΔI[k] of each desire, such that the notification from the output semantics converter module 78 influence the amount of variation of the emotion ΔI[k] of the parameter value of ‘fatigue’.

In the present specified example, the parameter values of the respective emotions and desires (instinct) are controlled to be changed in a range from 0 to 100, while the values of the coefficients ke and ki are also individually set for each emoton and for each desire.

On the other hand, the output semantics converter module 78 of the middleware layer 50 provides abstract behavior commands provided from the behavior switching module 81 of the application layer 51, such as ‘advance’, ‘rejoice’, ‘cry’ or ‘tracking a ball’, to corresponding signal processing modules 71 to 77 of an output system 79, as shown in FIG. 27.

When supplied with a behavior command, the signal processing modules 71 to 77 generate servo command values to be sent to the relevant actuators, voice data of the voice output from the loudspeaker or the actuating data to be supplied to the LED, and send these data sequentially through the virtual robot 43 of the robotics server object 42 and the signal processing circuit to the associated actuator, loudspeaker or to the LED.

In this manner, the robot apparatus 1 is able to perform autonomous behaviors responsive to the own (inner) status and to the surrounding (outer) status, as well as to the commands and the actions from the user, based on the aforementioned control program.

Such control program is provided via a recording medium recorded so as to be readable by the robot apparatus 1. The recording medium for recording the control program may, for example, be a magnetic reading type recording medium, such as a magnetic tape, flexible disc, a magnetic card, an optical readout type recording medium, such as a CD-ROM, MO, CD-R or DVD. The recording medium includes a semiconductor memory, such as a so-called memory card or an IC card. The memory card may be rectangular or square in shape. The control program may also be supplied over e.g. the Internet.

The control program is reproduced by a dedicated read-in driver or a personal computer or transmitted via wired or wireless connection to the robot apparatus 1 for readout. In case the robot apparatus 1 is provided with a drive device for a small-sized recording medium, such as a semiconductor memory or an IC card, the robot apparatus 1 may directly read it out from the recording medium.

What is claimed is:

1. A behavior controlling apparatus for controlling the behavior of a mobile robot apparatus, said behavior controlling apparatus comprising:
landmark recognition means for recognizing a plurality of landmarks arranged discretely;
landmark map building means for integrating the locations of said landmarks recognized by said landmark recognition means for building a landmark map based on the geometrical topology of said landmarks;
mobility area recognition means for building a mobility area map, indicating the mobility area where the mobile robot apparatus can move, from said landmark map built by said landmark map building means; and
behavior controlling means for controlling the behavior of said mobile robot apparatus using the mobility area map built by said mobility area recognition means.

2. The behavior controlling apparatus according to claim 1 wherein said landmark map building means integrates the landmark information recognized by said landmark recognition means and the odometric information of the robot apparatus itself to estimate the geometric positions of said landmarks and outputs said geometric positions as a landmark map.

3. The behavior controlling apparatus according to claim 1 wherein said behavior controlling means adds said mobility area map as a virtual obstacle in an obstacle map of the environment around said robot apparatus and controls the behavior of said robot apparatus so that said robot apparatus will move only in an area determined to be a free area in said obstacle map.

4. A behavior controlling method for controlling the behavior of a mobile robot apparatus, said behavior controlling method comprising:
a landmark recognition step of recognizing a plurality of landmarks arranged discretely;
a landmark map building step of integrating the locations of said landmarks recognized by said landmark recognition step for building a landmark map based on the geometrical topology of said landmarks;
a mobility area recognition step of building a mobility area map, indicating the mobility area where the mobile robot apparatus can move, from said landmark map built by said landmark map building means; and
a behavior controlling step of controlling the behavior of said mobile robot apparatus using the mobility area map built by said mobility area recognition means.

5. A behavior controlling program run by a mobile robot apparatus for controlling the behavior of said mobile robot apparatus, said behavior controlling program comprising:
a landmark recognition step of recognizing a plurality of landmarks arranged discretely;
a landmark map building step of integrating the locations of said landmarks recognized by said landmark recognition step for building a landmark map based on the geometrical topology of said landmarks;
a mobility area recognition step of building a mobility area map, indicating the mobility area where the mobile robot apparatus can move, from said landmark map built by said landmark map building means; and
a behavior controlling step of controlling the behavior of said mobile robot apparatus using the mobility area map built by said mobility area recognition means.

6. A mobile robot apparatus including at least one movable leg and a trunk provided with information processing means, said mobile robot apparatus moving on a floor surface as the apparatus recognizes an object on said floor surface, said mobile robot apparatus comprising:
landmark recognition means for recognizing a plurality of landmarks arranged discretely;
landmark map building means for integrating the locations of said landmarks recognized by said landmark recognition means for building a landmark map based on the geometrical topology of said landmarks;
mobility area recognition means for building a mobility area map, indicating the mobility area where the mobile robot apparatus can move, from said landmark map built by said landmark map building means; and
behavior controlling means for controlling the behavior of said mobile robot apparatus using the mobility area map built by said mobility area recognition means.

7. The mobile robot apparatus according to claim 6 wherein
said landmark map building means integrates the landmark information recognized by said landmark recognition means and the odometric information of the robot apparatus itself to estimate the geometric positions of said landmarks and outputs said geometric positions as a landmark map.

8. The mobile robot apparatus according to claim 6 wherein
said behavior controlling means adds said mobility area map as a virtual obstacle in the obstacle map of the environment around said robot apparatus and controls the behavior of said robot apparatus so that said robot apparatus will move only in an area determined to be a free area in said obstacle map.
